(19) United States
(12) Patent Application Publication
(10) Pub. No.: US 2024/0196240 A1
(43) Pub. Date: Jun. 13, 2024

(54) RADIO LINK MONITORING IN FULL-DUPLEX SYSTEMS

(71) Applicant: Samsung Electronics Co., Ltd., Suwon-si (KR)

(72) Inventors: Marian Rudolf, Longueuil (CA); Aristides Papasakellariou, Houston, TX (US)

(21) Appl. No.: 18/516,875

(22) Filed: Nov. 21, 2023

Related U.S. Application Data
(60) Provisional application No. 63/431,250, filed on Dec. 8, 2022.

(51) Int. Cl. H04W 24/08; H04L 5/00; H04W 72/0446; H04W 72/542

(52) U.S. Cl. CPC H04W 24/08; H04L 5/0051; H04W 72/0446; H04W 72/542

(57) ABSTRACT

Radio link monitoring in full-duplex systems. A method includes receiving first information for a first set of radio link monitoring (RLM) reference signals (RSs) corresponding to a first subset of slots on a cell and receiving second information for a second set of RLM RSS corresponding to a second subset of slots on the cell. The method further includes determining a radio link failure for the first subset of slots when a reception quality of any of the first set of RLM RSs is below a reception quality threshold for a time period and determining a radio link failure for the second subset of slots when a reception quality of any of the second set of RLM RSs is below a reception quality threshold for a time period. The second subset of slots includes time-domain resources indicated for simultaneous transmission and reception and the first subset of slots do not.

### CROSS-REFERENCE TO RELATED APPLICATION AND CLAIM OF PRIORITY

This application claims priority under 35 U.S.C. § 119(e) to U.S. Provisional Patent Application No. 63/431,250 filed on Dec. 8, 2022. The above-identified provisional patent application is hereby incorporated by reference in its entirety.

### TECHNICAL FIELD

The present disclosure relates generally to wireless communication systems and, more specifically, relates to radio link monitoring in full-duplex systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to radio link monitoring in full-duplex systems.

In an embodiment, a method of operating a user equipment (UE) is provided. The method includes receiving first information for a first set of radio link monitoring (RLM) reference signals (RSs) and a first set of parameters associated with an evaluation of the first set of RLM RSs and receiving second information for a second set of RLM RSs and a second set of parameters associated with an evaluation of the second set of RLM RSs. The first set of RLM RSs corresponds to a first subset of slots from a set of slots on a cell. The second set of RLM RSs corresponds to a second subset of slots from the set of slots on the cell. The method further includes determining, based on the first set of parameters, a first reception quality for the first set of RLM RSS, determining a radio link failure for the first subset of slots when a reception quality of any RLM RS from the first set of RLM RSs is below a first reception quality threshold for a first time period, determining, based on the second set of parameters, a second reception quality for the second set of RLM RSs, and determining a radio link failure for the second subset of slots when a reception quality of any RLM RS from the second set of RLM RSs is below a second reception quality threshold for a second time period. The first subset of slots do not include time-domain resources indicated for simultaneous transmission and reception on the cell. The second subset of slots includes time-domain resources indicated for simultaneous transmission and reception on the cell.

In another embodiment, a UE is provided. The UE includes a transceiver configured to receive first information for a first set of RLM RSs and a first set of parameters associated with an evaluation of the first set of RLM RSs and receive second information for a second set of RLM RSs and a second set of parameters associated with an evaluation of the second set of RLM RSs. The first set of RLM RSs corresponds to a first subset of slots from a set of slots on a cell. The second set of RLM RSs corresponds to a second subset of slots from the set of slots on the cell. The UE further includes a processor operably coupled to the transceiver. The processor is configured to determine, based on the first set of parameters, a first reception quality for the first set of RLM RSs; determine a radio link failure for the first subset of slots when a reception quality of any RLM RS from the first set of RLM RSs is below a first reception quality threshold for a first time period; determine, based on the second set of parameters, a second reception quality for the second set of RLM RSs; and determine a radio link failure for the second subset of slots when a reception quality of any RLM RS from the second set of RLM RSs is below a second reception quality threshold for a second time period. The first subset of slots does not include time-domain resources indicated for simultaneous transmission and reception on the cell. The second subset of slots includes time-domain resources indicated for simultaneous transmission and reception on the cell.

In yet another embodiment, a base station (BS) is provided. The BS includes a transceiver configured to transmit first information for a first set of RLM RSs and a first set of parameters associated with an evaluation of the first set of RLM RSs and transmit second information for a second set of RLM RSs and a second set of parameters associated with an evaluation of the second set of RLM RSs. The first set of RLM RSs corresponds to a first subset of slots from a set of slots on a cell. The second set of RLM RSs corresponds to a second subset of slots from the set of slots on the cell. A radio link failure for the first subset of slots is based on a reception quality, that is based on the first set of parameters, of any RLM RS from the first set of RLM RSs being below a first reception quality threshold for a first time period. A radio link failure for the second subset of slots is based on a reception quality, that is based on the first set of parameters, of any RLM RS from the second set of RLM RSs being below a second reception quality threshold for a second time period. The first subset of slots does not include time-domain resources indicated for simultaneous transmission and reception on the cell. The second subset of slots includes time-domain resources indicated for simultaneous transmission and reception on the cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example base station according to embodiments of the present disclosure;

FIG. 3 illustrates an example user equipment (UE) according to embodiments of the present disclosure;

FIGS. 4A-B illustrate example wireless transmit and receive paths according to embodiments of the present disclosure;

FIG. 5 illustrates a transmitter block diagram for a physical downlink shared channel (PDSCH) in a slot according to embodiments of the present disclosure;

FIG. 6 illustrates a receiver block diagram for a PDSCH in a slot according to embodiments of the present disclosure;

FIG. 7 illustrates a transmitter block diagram for a physical uplink shared channel (PUSCH) in a slot according to embodiments of the present disclosure;

FIG. 8 illustrates a receiver block diagram for a PUSCH in a slot according to embodiments of the present disclosure;

FIG. 9 illustrates an example antenna blocks or arrays forming beams according to embodiments of the present disclosure;

FIG. 10 illustrates an example uplink/downlink (UL-DL) frame configuration in a time-division duplex (TDD) communication system configuration in accordance with various embodiments of this disclosure;

FIG. 11 illustrates an example UL-DL frame configurations in a full-duplex (FD) communication system, in accordance with various embodiments of this disclosure;

FIG. 12 illustrates an example diagram of a full duplex communication system using two RLM-RS groups, in accordance with various embodiments of this disclosure;

FIG. 13 illustrates a flow chart of a full-duplex communication system using two RLM-RS groups to evaluate radio link quality according to various embodiments of this disclosure;

FIG. 14 illustrates a flow chart of a full-duplex communication system using two RLM-RS groups to select an RLM-RS group, in accordance with various embodiments of this disclosure;

FIG. 15 illustrates an example diagram of a full duplex communication system using two RLM-RS groups configured with different out-of-sync and in-sync block error rates, in accordance with various embodiments of this disclosure;

FIG. 16 illustrates an example diagram of a full-duplex communication system using two RLM-RS groups with different parameter sets;

FIG. 17 illustrates an example diagram of a full-duplex communication system using two RLM-RS groups configured with an adjustment or offset value according to various embodiments of this disclosure; and

FIG. 18 illustrates an example process flow chart of a full-duplex communication system using two RLM-RS groups to indicate radio link monitoring group failure or re-establishment, in accordance with various embodiments of this disclosure.

### DETAILED DESCRIPTION

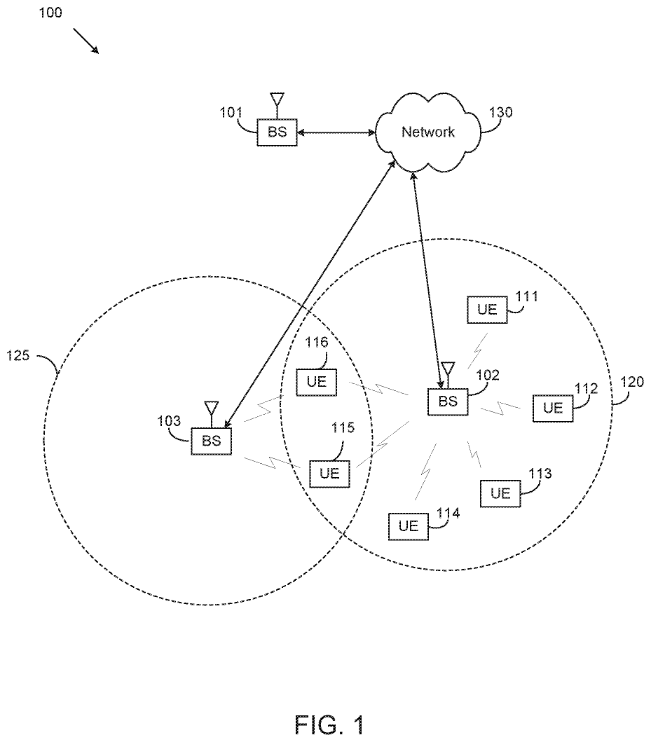

FIGS. 1 through 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 38.211 v17.2.0, “NR; Physical channels and modulation” (REF1); 3GPP TS 38.212 v17.2.0, “NR; Multiplexing and Channel coding” (REF2); 3GPP TS 38.213 v17.2.0, “NR; Physical Layer Procedures for Control” (REF3); 3GPP TS 38.214 v17.2.0, “NR; Physical Layer Procedures for Data” (REF4); 3GPP TS 38.321 v17.1.0, “NR; Medium Access Control (MAC) protocol specification” (REF5); 3GPP TS 38.331 v17.1.0, “NR; Radio Resource Control (RRC) Protocol Specification” (REF6); 3GPP TS 38.306 v17.1.0, “NR; User Equipment (UE) radio access capabilities” (REF7); and 3GPP TS 38.133 v17.2.0, “NR; Requirements for support of radio resource management” (REF8).

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for radio link monitoring in full-duplex systems. In certain embodiments, one or more of the BSs 101-103 include circuitry, programing, or a combination thereof to support radio link monitoring in full-duplex systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

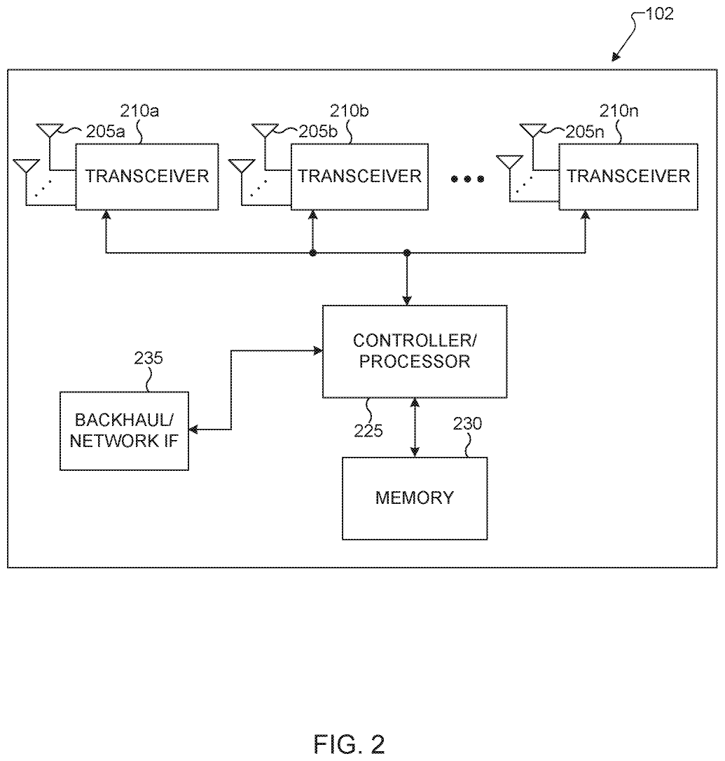

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

In various embodiments, the controller/processor 225 performs processes to support radio link monitoring in full-duplex systems. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs. In embodiments of this disclosure, the gNB 102 may communicate an RLM-RS group to a UE (e.g., UE 116), and receive an indication of in-syn or out-of-sync from a UE (e.g., UE 116), via, e.g., any one of the antennas 205a-205n.

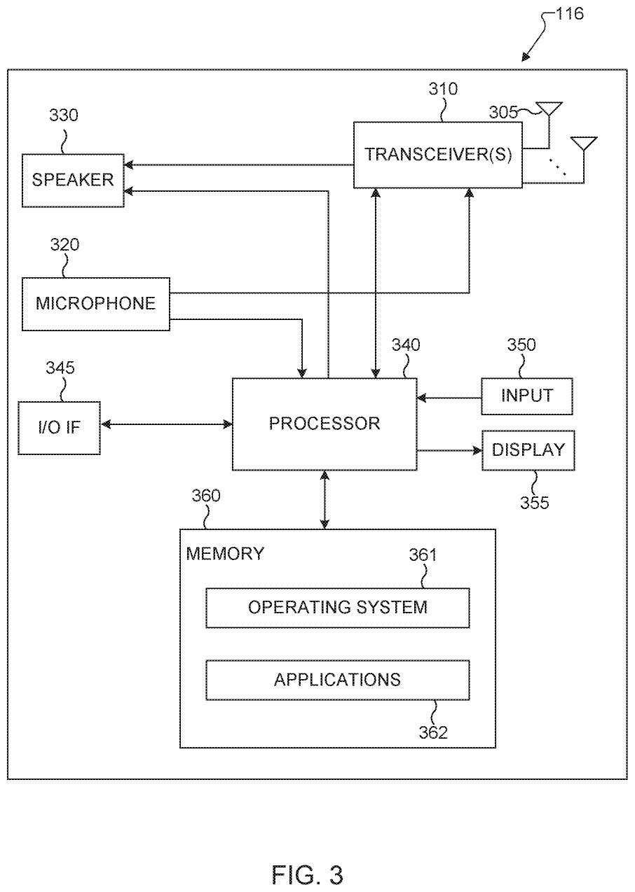

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data). In embodiments of this disclosure, the UE 116 may receive an RLM-RS group from a gNB (e.g., UE 102), and transmit an indication of in-syn or out-of-sync to a gNB (e.g., gNB 102), via the antenna 305.

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

In various embodiments, the processor 340 performs processes for radio link monitoring in full-duplex systems. The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

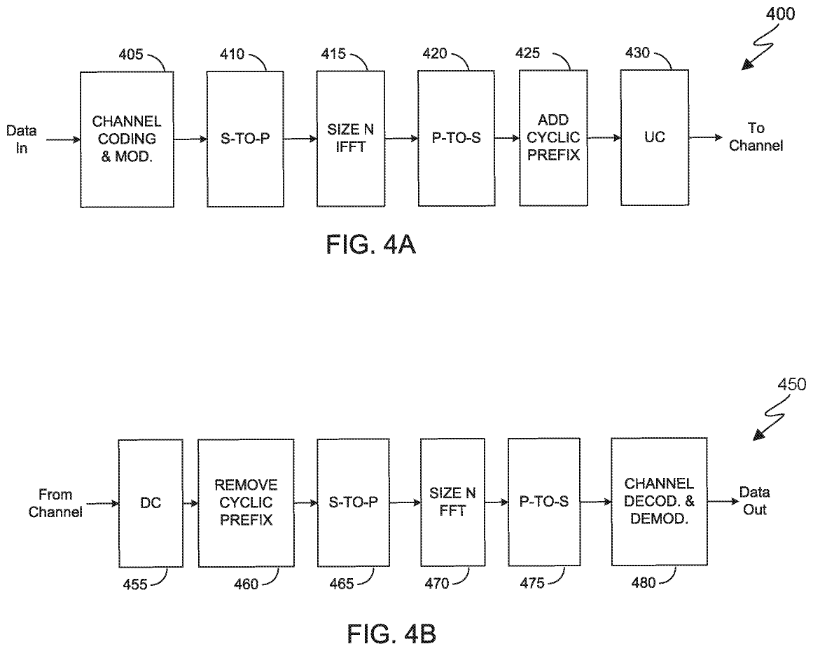

FIGS. 4A-B illustrate example wireless transmit and receive paths according to this disclosure. In the following description, a transmit path 400 of FIG. 4A, may be described as being implemented in an gNB (such as the gNB 102), while a receive path 450 of FIG. 4B, may be described as being implemented in a UE (such as a UE 116). However, it may be understood that the receive path 450 can be implemented in a BS and that the transmit path 400 can be implemented in a UE. In some embodiments, the receive path 450 is configured to perform radio link monitoring in full-duplex systems as described in embodiments of the present disclosure.

The transmit path 400 as illustrated in FIG. 4A includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 450 as illustrated in FIG. 4B includes a down-converter (DC) 455, a remove cyclic prefix block 460, a serial-to-parallel (S-to-P) block 465, a size N fast Fourier transform (FFT) block 470, a parallel-to-serial (P-to-S) block 475, and a channel decoding and demodulation block 480.

As illustrated in FIG. 4A, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at a UE (e.g., 116) after passing through the wireless channel, and reverse operations to those at the gNB 102 are performed at the UE (e.g., 116).

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time domain signals. The size N FFT block 470 performs an FFT algorithm to generate N parallel frequency-domain signals. The parallel-to-serial block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 as illustrated in FIG. 4A that is analogous to transmitting in the downlink to UEs 111-116 and may implement a receive path 500 as illustrated in FIG. 4B that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4A and FIG. 4B can be implemented using hardware or using a combination of hardware and software/firmware. As a particular example, at least some of the components in FIG. 4 and FIG. 4B may be implemented in software, while other components may be implemented by configurable hardware or a mixture of software and configurable hardware. For instance, the FFT block 470 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. FIGS. 4A-B may also be generally implemented using TDD UL-DL operations.

Although FIGS. 4A-B illustrate examples of wireless transmit and receive paths, various changes may be made to FIGS. 4A-B. For example, various components in FIGS. 4A-B can be combined, further subdivided, or omitted and additional components can be added according to particular needs. Also, FIGS. 4A-B are meant to illustrate examples of the types of transmit and receive paths that can be used in a wireless network. Any other suitable architectures can be used to support wireless communications in a wireless network.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process consists of NZP CSI-RS and CSI-IM resources. In embodiments of this disclosure, the gNB may transmit one or more RLM-RS groups to a UE.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes HARQ acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may use spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are QCL with QCL type A, type D (when applicable) and average gain. The UE may further assume that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi co-location types corresponding to each DL RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

The UE receives a MAC-CE activation command to map up to [N] (e.g., N=8) TCI states to the codepoints of the DCI field “Transmission Configuration Indication.” When the HARQ-ACK corresponding to the PDSCH carrying the activation command is transmitted in slot n, the indicated mapping between TCI states and codepoints of the DCI field “Transmission Configuration Indication” may be applied after a MAC-CE application time, e.g., starting from the first slot that is after slot (n+3Nₛₗₒₜ^{subframe,μ}) where Nₛₗₒₜ^{subframe,μ} is a number of slot per subframe for subcarrier spacing (SCS) configuration μ.

In embodiments of this disclosure, the wireless transmit and receive paths may involve communications related to RLM-RS groups and in-sync of out-of-sync indications from a UE to a gNB as part of radio link monitoring in full duplex systems, as described in further detail below.

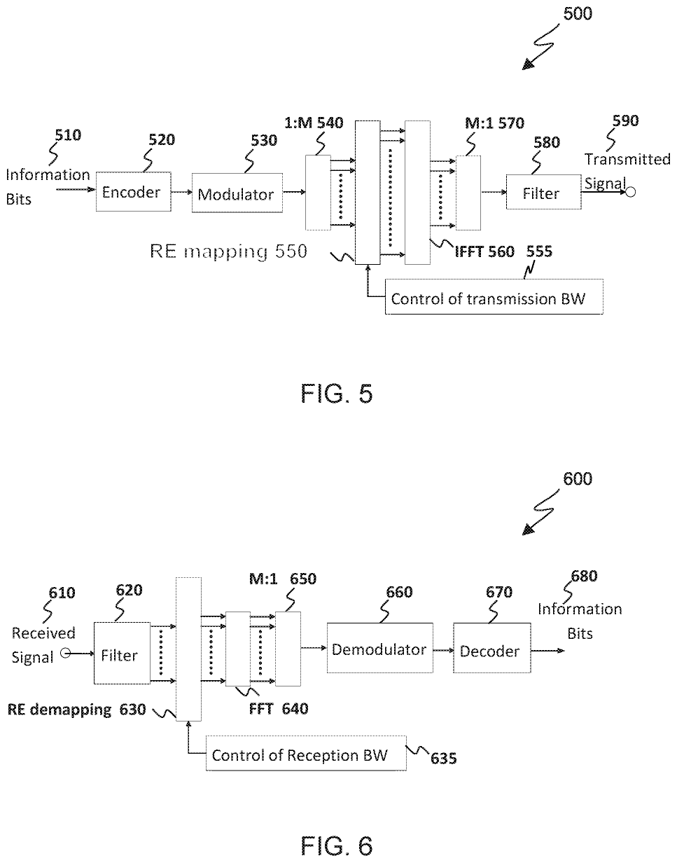

FIG. 5 illustrates a transmitter block diagram 500 for a PDSCH in a slot according to embodiments of the present disclosure. The embodiment of the transmitter block diagram 500 illustrated in FIG. 5 is for illustration only. One or more of the components illustrated in FIG. 5 can be implemented in specialized circuitry configured to perform the noted functions or one or more of the components can be implemented by one or more processors executing instructions to perform the noted functions. FIG. 5 does not limit the scope of this disclosure to any particular implementation of the transmitter block diagram 500.

As shown in FIG. 5, information bits 510 are encoded by encoder 520, such as a turbo encoder, and modulated by modulator 530, for example using quadrature phase shift keying (QPSK) modulation. A serial to parallel (S/P) converter 540 generates M modulation symbols that are subsequently provided to a mapper 550 to be mapped to REs selected by a transmission BW selection unit 555 for an assigned PDSCH transmission BW, unit 560 applies an Inverse fast Fourier transform (IFFT), the output is then serialized by a parallel to serial (P/S) converter 570 to create a time domain signal, filtering is applied by filter 580, and a signal transmitted 590. Additional functionalities, such as data scrambling, cyclic prefix insertion, time windowing, interleaving, and others are well known in the art and are not shown for brevity. In embodiments of this disclosure, the transmitter block diagram 500 may be used to facilitate radio link monitoring in full duplex systems as discussed in further detail below.

FIG. 6 illustrates a receiver block diagram 600 for a PDSCH in a slot according to embodiments of the present disclosure. The embodiment of the diagram 600 illustrated in FIG. 6 is for illustration only. One or more of the components illustrated in FIG. 6 can be implemented in specialized circuitry configured to perform the noted functions or one or more of the components can be implemented by one or more processors executing instructions to perform the noted functions. FIG. 6 does not limit the scope of this disclosure to any particular implementation of the diagram 600.

As shown in FIG. 6, a received signal 610 is filtered by filter 620, REs 630 for an assigned reception BW are selected by BW selector 635, unit 640 applies a fast Fourier transform (FFT), and an output is serialized by a parallel-to-serial converter 650. Subsequently, a demodulator 660 coherently demodulates data symbols by applying a channel estimate obtained from a DMRS or a CRS (not shown), and a decoder 670, such as a turbo decoder, decodes the demodulated data to provide an estimate of the information data bits 680. Additional functionalities such as time-windowing, cyclic prefix removal, de-scrambling, channel estimation, and de-interleaving are not shown for brevity. In embodiments of this disclosure, the receiver block diagram 600 may be used to facilitate radio link monitoring in full duplex systems as discussed in further detail below.

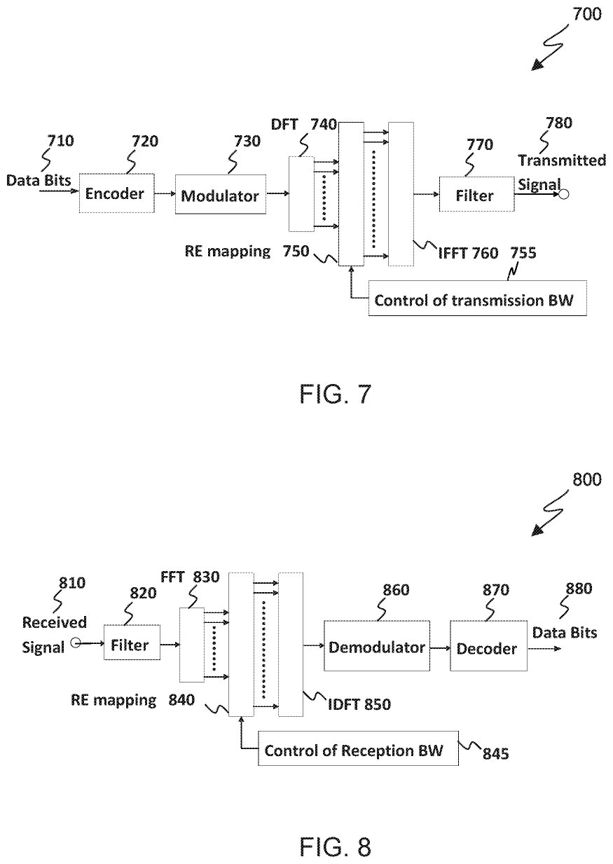

FIG. 7 illustrates a transmitter block diagram 700 for a PUSCH in a slot according to embodiments of the present disclosure. The embodiment of the block diagram 700 illustrated in FIG. 7 is for illustration only. One or more of the components illustrated in FIG. 5 can be implemented in specialized circuitry configured to perform the noted functions or one or more of the components can be implemented by one or more processors executing instructions to perform the noted functions. FIG. 7 does not limit the scope of this disclosure to any particular implementation of the block diagram 700.

As shown in FIG. 7, information data bits 710 are encoded by encoder 720, such as a turbo encoder, and modulated by modulator 730. A discrete Fourier transform (DFT) unit 740 applies a DFT on the modulated data bits, REs 750 corresponding to an assigned PUSCH transmission BW are selected by transmission BW selection unit 855, unit 760 applies an IFFT and, after a cyclic prefix insertion (not shown), filtering is applied by filter 770 and a signal transmitted 780. In embodiments of this disclosure, the transmitter block diagram 700 may be used to facilitate radio link monitoring in full duplex systems as discussed in further detail below.

FIG. 8 illustrates a receiver block diagram 800 for a PUSCH in a subframe according to embodiments of the present disclosure. The embodiment of the block diagram 800 illustrated in FIG. 8 is for illustration only. One or more of the components illustrated in FIG. 8 can be implemented in specialized circuitry configured to perform the noted functions or one or more of the components can be implemented by one or more processors executing instructions to perform the noted functions. FIG. 8 does not limit the scope of this disclosure to any particular implementation of the block diagram 800.

As shown in FIG. 8, a received signal 810 is filtered by filter 820. Subsequently, after a cyclic prefix is removed (not shown), unit 830 applies an FFT, REs 840 corresponding to an assigned PUSCH reception BW are selected by a reception BW selector 845, unit 850 applies an inverse DFT (IDFT), a demodulator 860 coherently demodulates data symbols by applying a channel estimate obtained from a DMRS (not shown), a decoder 870, such as a turbo decoder, decodes the demodulated data to provide an estimate of the information data bits 880. In embodiments of this disclosure, the receiver block diagram 800 may be used to facilitate radio link monitoring in full duplex systems as discussed in further detail below.

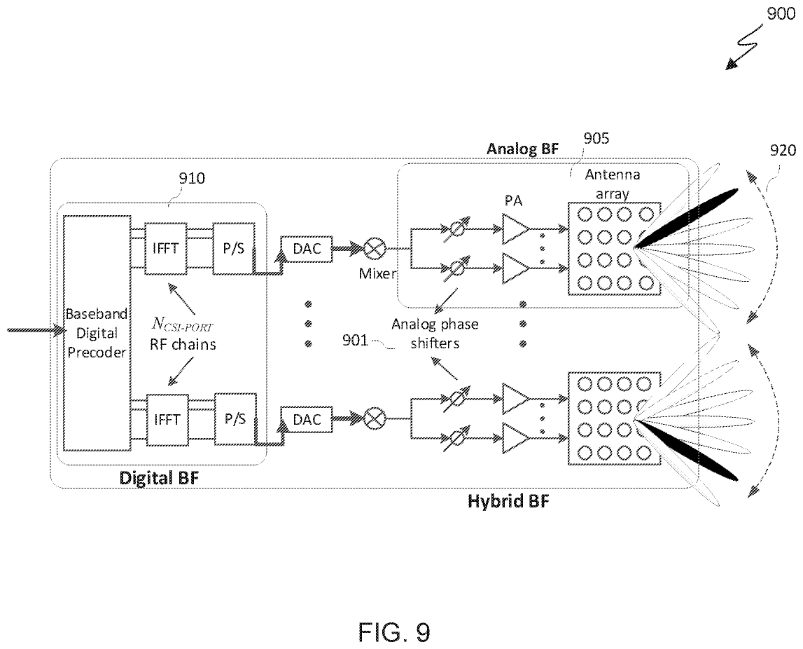

FIG. 9 illustrates an example antenna blocks or arrays 900 according to embodiments of the present disclosure. The embodiment of the antenna blocks or arrays 900 illustrated in FIG. 9 is for illustration only. FIG. 9 does not limit the scope of this disclosure to any particular implementation of the antenna blocks or arrays 900.

Rel-15 NR specifications support up to 32 CSI-RS antenna ports which enable a gNB to be equipped with a large number of antenna elements (such as 64 or 128). In this case, a plurality of antenna elements is mapped onto one CSI-RS port. For FR2, e.g., mmWave bands, although the number of antenna elements can be larger for a given form factor, the number of CSI-RS ports which can correspond to the number of digitally precoded ports—tends to be limited due to hardware constraints (such as the feasibility to install a large number of ADCs/DACs at mmWave frequencies) as illustrated in FIG. 9. In this case, one CSI-RS port is mapped onto a large number of antenna elements which can be controlled by a bank of analog phase shifters 901. One CSI-RS port can then correspond to one sub-array which produces a narrow analog beam through analog beamforming 905. This analog beam can be configured to sweep across a wider range of angles (920) by varying the phase shifter bank across symbols or subframes. The number of sub-arrays (equal to the number of RF chains) is the same as the number of CSI-RS ports N_{CSI-PORT}. A digital beamforming unit 910 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as FR2-2, e.g., >52.6 GHz. In this case, the system can employ only analog beams. Due to the O2 absorption loss around 60 GHz frequency (˜10 dB additional loss@100 m distance), larger number of and sharper analog beams (hence larger number of radiators in the array) will be needed to compensate for the additional path loss. The antenna blocks or arrays 900 may be used to facilitate radio link monitoring in full duplex systems as discussed in further detail below.

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous PRBs which represents the smallest frequency unit for CSI or calibration coefficient reporting. The number of PRBs in a subband can be fixed for a given value of DL system bandwidth, configured either semi-statically via higher layer/RRC signaling, or dynamically via L1 DL control signaling or MAC control element (MAC CE). The number of PRBs in a subband can be included in CSI or calibration coefficient reporting setting. The term “CSI reporting band” is defined as a set/collection of subbands, either contiguous or non-contiguous, wherein CSI or calibration coefficient reporting is performed. For example, CSI or calibration coefficient reporting band can include all the subbands within the DL system bandwidth. This can also be termed “fullband”. Alternatively, CSI or calibration coefficient reporting band can include only a collection of subbands within the DL system bandwidth. This can also be termed “partial band”. The term “CSI reporting band” is used only as an example for representing a function. Other terms such as “CSI reporting subband set” or “CSI or calibration coefficient reporting bandwidth” can also be used.

In terms of UE configuration, a UE can be configured with at least one CSI or calibration coefficient reporting band. This configuration can be semi-static (via higher layer signaling or RRC) or dynamic (via MAC CE or L1 DL control signaling). When configured with multiple (N) CSI or calibration coefficient reporting bands (e.g., via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for all the Mn subbands within the CSI reporting band. A CSI parameter is configured with “subband” for the CSI reporting band with Mn subbands when one CSI parameter is reported for each of the Mn subbands within the CSI reporting band.

In embodiments of this disclosure, 5G NR radio supports time-division duplex (TDD) operation and frequency division duplex (FDD) operation. Use of FDD or TDD depends on the NR frequency band and per-country allocations. TDD is required in most bands above 2.5 GHz.

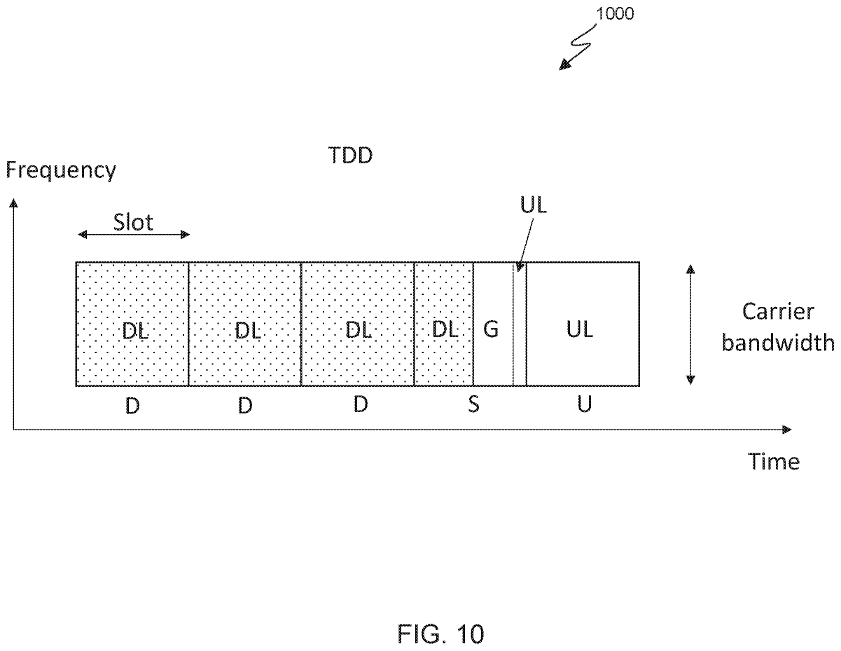

FIG. 10 illustrates an example diagram 1000 of structure of slots for a TDD communications system according to the embodiments of the disclosure. The diagram 1000 is for illustration only and other embodiments can be used without departing from the scope of the present disclosure.

A DDDSU UL-DL configuration is shown in FIG. 10. Here, D denotes a DL slot, U denotes an UL slot, and S denotes a special or switching slot with a DL part, a flexible part that can also be used as guard period G for DL-to-UL switching, and optionally an UL part.

TDD has a number of advantages over FDD. For example, use of the same band for DL and UL transmissions leads to simpler UE implementation with TDD because a duplexer is not required. Another advantage is that time resources can be flexibly assigned to UL and DL considering an asymmetric ratio of traffic in both directions. DL is typically assigned most time resources in TDD to handle DL-heavy mobile traffic. Another advantage is that CSI can be more easily acquired via channel reciprocity. This reduces an overhead associated with CSI reports especially when there is a large number of antennas.

Although there are advantages of TDD over FDD, there are also disadvantages. A first disadvantage is a smaller coverage of TDD due to the smaller portion of time resources available for transmissions from a UE, while with FDD all time resources can be used. Another disadvantage is latency. In TDD, a timing gap between reception by a UE and transmission from a UE containing the hybrid automatic repeat request acknowledgement (HARQ-ACK) information associated with receptions by the UE is typically larger than that in FDD, for example by several milliseconds. Therefore, the HARQ round trip time in TDD is typically longer than that with FDD, especially when the DL traffic load is high. This causes increased UL user plane latency in TDD and can cause data throughput loss or even HARQ stalling when a PUCCH providing HARQ-ACK information needs to be transmitted with repetitions in order to improve coverage (an alternative in such case is for a network to forgo HARQ-ACK information at least for some transport blocks in the DL).

To address some of the disadvantages for TDD operation, an adaptation of link direction based on physical layer signaling using a DCI format is supported where, with the exception of some symbols in some slots supporting predetermined transmissions such as for SSBs, symbols of a slot can have a flexible direction (UL or DL) that a UE can determine according to scheduling information for transmissions or receptions. A PDCCH can also be used to provide a DCI format, such as a DCI format 2_0 as described in REF3, that can indicate a link direction of some flexible symbols in one or more slots. Nevertheless, in actual deployments, it is difficult for a gNB scheduler to adapt a transmission direction of symbols without coordination with other gNB schedulers in the network. This is because of CLI where, for example, DL receptions in a cell by a UE can experience large interference from UL transmissions in the same or neighboring cells from other UEs.

FD communications offer a potential for increased spectral efficiency, improved capacity, and reduced latency in wireless networks. When using FD communications, a gNB or a UE simultaneously receives and transmits on fully or partially overlapping, or adjacent, frequency resources, thereby improving spectral efficiency and reducing latency in user and/or control planes.

There are several options for operating a FD wireless communication system. For example, a single carrier may be used such that transmissions and receptions are scheduled on same time-domain resources, such as symbols or slots. Transmissions and receptions on same symbols or slots may be separated in frequency, for example by being placed in non-overlapping sub-bands. An UL frequency sub-band, in time-domain resources that also include DL frequency sub-bands, may be located in the center of a carrier, or at the edge of the carrier, or at a selected frequency-domain position of the carrier. The allocations of DL sub-bands and UL sub-bands may also partially or even fully overlap. A gNB may simultaneously transmit and receive in time-domain resources using same physical antennas, antenna ports, antenna panels and transmitter-receiver units (TRX). Transmission and reception in FD may also occur using separate physical antennas, ports, panels, or TRXs. Antennas, ports, panels, or TRXs may also be partially reused, or only respective subsets can be active for transmissions and receptions when FD communication is enabled.

When a UE receives signals/channels from a gNB in a full-duplex slot, the receptions may be scheduled in a DL subband of the full-duplex slot. When full-duplex operation at the gNB uses DL slots for scheduling transmissions from the UE using full-duplex transmission and reception at the gNB, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB uses UL slots for purpose of scheduling transmissions to UEs using full-duplex transmission and reception at the gNB, there may be one or multiple, such as two, UL subbands in the full-duplex slot. Full-duplex operation using an UL subband or a DL subband may be referred to as Subband-Full-Duplex (SBFD).

For example, when full-duplex operation at the gNB uses a DL or F slot or symbol for scheduling transmissions from the UE using full-duplex transmission and reception at the gNB, there may be one DL subband on the full-duplex slot or symbol and one UL subband of the full-duplex slot or symbol in the NR carrier. A frequency-domain configuration of the DL and UL subbands may then be referred to as ‘DU’ or ‘UD’, respectively, depending on whether the UL subband is configured/indicated in the upper or the lower part of the NR carrier. In another example, when full-duplex operation at the gNB uses a DL or F slot or symbol for scheduling transmissions from the UE using full-duplex transmission and reception at the gNB, there may be two, DL subbands and one UL subband on the full-duplex slot or symbol. A frequency-domain configuration of the DL and UL subbands may then be referred to as ‘DUD’ when the UL subband is configured/indicated in a part of the NR carrier and the DL subbands are configured/indicated at the edges of the NR carrier, respectively.

In the following, for brevity, full-duplex slots/symbols and SBFD slots/symbols may be jointly referred to as SBFD slots/symbol and non-full-duplex slots/symbols and normal DL or UL slot/symbols may be referred to as non-SBFD slots/symbols.

Instead of using a single carrier, it is also possible to use different component carriers (CCs) for receptions and transmissions by a UE. For example, receptions by a UE can occur on a first CC and transmissions by the UE occur on a second CC having a small, including zero, frequency separation from the first CC. For example, when carrier-aggregation based full-duplex operation is used, an SBFD subband may correspond to a component carrier or a part of a component carrier or an SBFD subband may be allocated using parts of multiple component carriers.

In one example, the gNB may support full-duplex operation, e.g., support simultaneous DL transmission to a UE in an SBFD DL subband and UL reception from a UE in an SBFD UL subband on an SBFD slot or symbol. In one example, the gNB-side may support full-duplex operation using multiple TRPs, e.g., TRP A may be used for simultaneous DL transmission to a UE and TRP B for UL reception from a UE on an SBFD slot or symbol.

Full-duplex operation may be supported by a half-duplex UE or by a full-duplex UE. A UE operating in half-duplex mode can transmit or receive but cannot simultaneously transmit and receive on a same symbol. A UE operating in full-duplex mode can simultaneously transmit and receive on a same symbol. For example, a UE can operate in full-duplex mode on a single NR carrier or based on the use of intra-band or inter-band carrier aggregation.

For example, when the UE is capable of full-duplex operation, SBFD operation based on overlapping or non-overlapping subbands or using one or multiple UE antenna panels may be supported by the UE. In one example, an FR2-1 UE may support simultaneous transmission to the gNB and reception from the gNB on a same time-domain resource, e.g., symbol or slot. The UE capable of full-duplex operation may then be configured, scheduled, assigned or indicated with DL receptions from the gNB in an SBFD DL subband on a same SBFD symbol where the UE is configured, scheduled, assigned or indicated for UL transmissions to the gNB on an SBFD UL subband. In one example, the DL receptions by a UE may use a first UE antenna panel while the UL transmissions from the UE may use a second UE antenna panel on the same SBFD symbol/slot. For example, UE-side self-interference cancellation capability may be supported in the UE by one or a combination of techniques as described in the gNB case, e.g., based on spatial isolation provided by the UE antennas or UE antenna panels, or based on analog and/or digital equalization, or filtering. In one example, DL receptions by the UE in a first frequency channel, band or frequency range, may use a TRX of a UE antenna or UE antenna panel while the UL transmissions from the UE in a second frequency channel, band or frequency range may use the TRX on a same SBFD symbol/slot. For example, when the UE is capable of full-duplex operation based on the use of carrier aggregation, simultaneous DL reception from the gNB and UL transmission to the gNB on a same symbol may occur on different component carriers.

In the following, for brevity, a UE operating in half-duplex mode but supporting a number of enhancements for gNB-side full-duplex operation may be referred to as SBFD-aware UE. For example, the SBFD-aware UE may support time-domain or frequency-domain resource allocation enhancements to improve the UL coverage or throughput or spectral efficiency when operating on a serving cell with gNB-side SBFD support.

In the following, for brevity, a UE operating in full-duplex mode may be referred to as SBFD-capable UE, or as full-duplex capable UE, or as a full-duplex UE. A full-duplex UE may support a number of enhancements for gNB-side full-duplex operation. For example, the SBFD-capable UE may support time-domain or frequency-domain resource allocation enhancements to improve the UL coverage or throughput or spectral efficiency when operating on a serving cell.

In one example, a gNB may operate in full-duplex (or SBFD) mode and a UE operates in half-duplex mode. In one example, a gNB may operate in full-duplex (or SBFD) mode and a UE operates in full-duplex (or SBFD) mode. In one example, gNB-side support of full-duplex (or SBFD) operation is based on multiple TRPs wherein a TRP may operate in half-duplex mode, and a UE operates in full-duplex mode.

In one example, a TDD serving cell supports a mix of full-duplex and half-duplex UEs. For example, UE1 supports full-duplex operation and UE2 supports half-duplex operation. The UE1 can transmit and receive simultaneously in a slot or symbol when configured, scheduled, assigned or indicated by the gNB. UE2 can either transmit or receive in a slot or symbol while simultaneous DL reception by UE2 and UL transmission from UE2 cannot occur on the same slot or symbol.

FD transmission/reception is not limited to gNBs, TRPs, or UEs, but can also be used for other types of wireless nodes such as relay or repeater nodes.

Full duplex operation needs to overcome several challenges in order to be functional in actual deployments. When using overlapping frequency resources, received signals are subject to co-channel CLI and self-interference. CLI and self-interference cancellation methods include passive methods that rely on isolation between transmit and receive antennas, active methods that utilize RF or digital signal processing, and hybrid methods that use a combination of active and passive methods. Filtering and interference cancellation may be implemented in RF, baseband (BB), or in both RF and BB. While mitigating co-channel CLI may require large complexity at a receiver, it is feasible within current technological limits. Another aspect of FD operation is the mitigation of adjacent channel CLI because in several cellular band allocations, different operators have adjacent spectrum.

Throughout the disclosure, the term FD is used as a short form for a full-duplex operation in a wireless system. The terms Cross-Division-Duplex (XDD) and FD may be used interchangeably in the disclosure.

FD operation in NR can improve spectral efficiency, link robustness, capacity, and latency of UL transmissions. In an NR TDD system, transmissions from a UE are limited by fewer available transmission opportunities than receptions by the UE. For example, for NR TDD with SCS=30 kHz, DDDU (2 msec), DDDSU (2.5 msec), or DDDDDDDSUU (5 msec), the UL-DL configurations allow for an DL:UL ratio from 3:1 to 4:1. Any transmission from the UE can only occur in a limited number of UL slots, for example every 2, 2.5, or 5 msec, respectively.

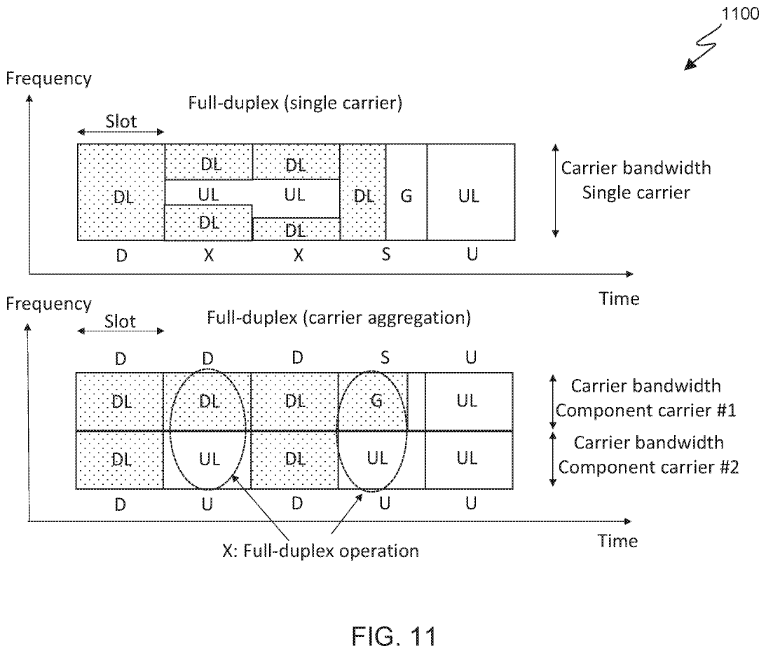

FIG. 11 illustrates two example FD configurations in a FD communications system 1100 according to embodiments of the disclosure. The embodiments of the FD configurations in a FD communications system 1100 is for illustration only. FIG. 11 does not limit the scope of this disclosure to any particular implementation of the FD communication system 1100 and other embodiments can be used without departing from the scope of the present disclosure.

For a single carrier TDD configuration with FD enabled, slots denoted as X are FD slots. Both DL and UL transmissions can be scheduled in FD slots for at least one or more symbols. The term FD slot is used to refer to a slot where UEs can simultaneously receive and transmit in at least one or more symbols of the slot if scheduled or assigned radio resources by the base station. A half-duplex UE cannot transmit and receive simultaneously in a FD slot or on a symbol of a FD slot. When a half-duplex UE is configured for transmission in symbols of a FD slot, another UE can be configured for reception in the symbols of the FD slot. A FD UE can transmit and receive simultaneously in symbols of a FD slot, possibly in presence of other UEs with resources for either receptions or transmissions in the symbols of the FD slot. Transmissions by a UE in a first FD slot can use same or different frequency-domain resources than in a second FD slot, wherein the resources can differ in bandwidth, a first RB, or a location of the center carrier.

When a UE receives signals/channels from a gNB in a full-duplex slot, the receptions may be scheduled in a DL subband of the full-duplex slot. When full-duplex operation at the gNB uses DL slots for scheduling transmissions from the UE using full-duplex transmission and reception at the gNB, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB uses UL slots for purpose of scheduling transmissions to UEs using full-duplex transmission and reception at the gNB, there may be one or multiple, such as two, UL subbands in the full-duplex slot.

For a carrier aggregation TDD configuration with FD enabled, a UE receives in a slot on CC #1 and transmits in at least one or more symbols of the slot on CC #2. In addition to D slots used only for transmissions/receptions by a gNB/UE, U slots used only for receptions/transmissions by the gNB/UE, and S slots that are used for both transmission and receptions by the gNB/UE and also support DL-UL switching, FD slots with both transmissions/receptions by a gNB or a UE that occur on same time-domain resources, such as slots or symbols, are labeled by X. For the example of TDD with SCS=30 kHz, single carrier, and UL-DL allocation DXXSU (2.5 msec), the second and third slots allow for FD operation. Transmissions from a UE can also occur in a last slot (U) where the full UL transmission bandwidth is available. FD slots or symbol assignments over a time period/number of slots can be indicated by a DCI format in a PDCCH reception and can then vary per unit of the time period, or can be indicated by higher layer signaling, such as via a MAC CE or RRC.

Although FIGS. 10-11 illustrate diagrams, various changes may be made to the diagrams 1000-1100 of FIGS. 10-11. For example, while certain diagrams (such as diagrams 1000, 1100) describe a certain slot structure, various components may be combined, further subdivided, or omitted or additional components can be added according to particular needs.

The DL radio link quality of the primary cell is monitored by a UE for the purpose of indicating out-of-sync/in-sync status to higher layers. The UE is not required to monitor the DL radio link quality in DL BWPs other than the active DL BWP. If a UE is configured with multiple DL BWPs for a serving cell, the UE performs RLM using RS(s) corresponding to resource indexes provided by RadioLinkMonitoringRS for the active DL BWP or, if RadioLinkMonitoringRS is not provided for the active DL BWP, using RS(s) provided for the active TCI state for PDCCH receptions in CORESETs on the active DL BWP.

A UE can be provided, for each DL BWP of a SpCell, a set of resource indexes, through a corresponding set of RadioLinkMonitoringRS, for radio link monitoring by parameter failure DetectionResources as defined in REF6. The UE is provided either a CSI-RS resource index, by parameter csi-RS-Index, or a SS/PBCH block index, by parameter ssb-Index.

For a CSI-RS resource, parameter powerControlOffsetSS is not applicable and a UE expects to be provided only ‘noCDM’ from cdm-Type, only ‘one’ and ‘three’ from density, and only ‘1 port’ from nrofPorts as described by REF4.

The UE can be provided up to N_{LR-RLM} RadioLinkMonitoringRS for link recovery procedures and for radio link monitoring. From the N_{LR-RLM} RadioLinkMonitoringRS, up to N_{RLM} RadioLinkMonitoringRS can be used for radio link monitoring depending on L_{MAX} as described in REF3, and up to two RadioLinkMonitoringRS can be used for link recovery procedures. For example, for the NR band n78 the parameters L_{MAX}=8, N_{LR-RLM}=6 and N_{RLM}=4 may be applied.

The UE monitors up to N_{RLM} RLM-RS resources in each corresponding carrier frequency range, depending on a maximum number of candidate SSBs per half frame according to REF3. When RLM-RS are not configured and no TCI state for PDCCH is activated, no RLM requirements are applicable.

If the UE is not provided RadioLinkMonitoringRS and the UE is provided for PDCCH receptions TCI states that include one or more CSI-RS, the UE uses for radio link monitoring the RS provided for the active TCI state for PDCCH reception if the active TCI state for PDCCH reception includes only one RS. If the active TCI state for PDCCH reception includes two RS, the UE expects that one RS is configured with qcl-Type set to ‘typeD’ and the UE uses the RS configured with qcl-Type set to ‘typeD’ for radio link monitoring. The UE does not expect both RS to be configured with qcl-Type set to ‘typeD’. The UE is not required to use for radio link monitoring an aperiodic or semi-persistent RS. For L_{MAX}=4, the UE selects the N_{RLM} RS provided for active TCI states for PDCCH receptions in CORESETs associated with the search space sets in an order from the shortest PDCCH monitoring periodicity. If more than one CORESETs are associated with search space sets having same PDCCH monitoring periodicity, the UE determines the order of the CORESET from the highest CORESET index as described in REF3.

A UE does not expect to use more than N_{RLM} RadioLinkMonitoringRS for radio link monitoring when the UE is not provided RadioLinkMonitoringRS.

In non-DRX mode operation, the physical layer in the UE assesses once per indication period the radio link quality, evaluated over the previous time period as defined in REF8 against thresholds (Qₒᵤₜ and Qᵢₙ) configured by rlmInSyncOutOfSyncThreshold. The UE determines the indication period as the maximum between the shortest periodicity for radio link monitoring resources and 10 milli-seconds. In DRX mode operation, the UE determines the indication period as the maximum between the shortest periodicity for radio link monitoring resources and the DRX period.

On each RLM-RS resource, the UE estimates the DL radio link quality and compares it to the thresholds Qₒᵤₜ and Qᵢₙ for the purpose of monitoring DL radio link quality of the cell. The threshold Qₒᵤₜ is defined as the level at which the DL radio link cannot be reliably received and corresponds to the out-of-sync block error rate (BLERₒᵤₜ) as defined in REF8. For SSB based and for CSI-RS based radio link monitoring, Q_{out_SSB} and Q_{out_CSI-RS}, respectively, are derived based on the hypothetical PDCCH transmission parameters defined in REF8. The threshold Qᵢₙ is defined as the level at which the DL radio link quality can be received with higher reliability than at Qₒᵤₜ and shall correspond to the in-sync block error rate (BLERᵢₙ) as defined in REF8. For SSB based and CSI-RS based radio link monitoring, Q_{in_SSB} and Q_{in_CSI-RS}, respectively, are defined in REF8. The UE evaluates whether the DL radio link quality on the configured RLM-RS resource estimated over the last T_{Evaluate_out_SSB} [msec] period becomes worse than the threshold Q_{out_SSB} within T_{Evaluate_out_SSB} [msec] evaluation period. The UE evaluates whether the DL radio link quality on the configured RLM-RS resource estimated over the last T_{Evaluate_in_SSB} [msec] period becomes better than the threshold Q_{in_SSB} within T_{Evaluate_in_SSB} [msec] evaluation period as defined in REF8. Similar principles apply to CSI-RS based radio link monitoring. Note that evaluation periods may be adjusted based on considerations such as measurement gaps and SMTC occasions as described in REF8.

The out-of-sync block error rate (BLERₒᵤₜ) and in-sync block error rate (BLERᵢₙ) are determined from the network configuration via parameter rlmInSyncOutOfSyncThreshold indicated by higher layers. When a UE is not provided rlmInSyncOutOfSyncThreshold from the network, the UE determines out-of-sync and in-sync block error rates from Configuration #0 in REF8 as default.

The physical layer in the UE indicates, in frames where the radio link quality is assessed, out-of-sync to higher layers when the radio link quality is worse than the threshold Qₒᵤₜ for all resources in the set of resources for radio link monitoring. When the radio link quality is better than the threshold Qᵢₙ for any resource in the set of resources for radio link monitoring, the physical layer in the UE indicates, in frames where the radio link quality is assessed, in-sync to higher layers.

When considering Radio Link Monitoring in a full-duplex wireless communication system, this disclosure recognizes that several issues need to be overcome.

A first issue is that evaluation of DL radio link quality using the configured RLM-RS resources on a non-full-duplex slot or symbol may not be representative of the DL radio link quality evaluated using RLM-RS resources on a full-duplex slot or symbol by the UE. In the following, for brevity, full-duplex slots/symbols and SBFD slots/symbols may be jointly referred to as SBFD slots/symbol and non-full-duplex slots/symbols and normal DL/UL slot/symbols may be jointly referred to as non-SBFD slots/symbols. When using an RLM-RS resource configured in a non-SBFD slot or symbol or multiple RLM-RS resources configured in both non-SBFD and SBFD slots or symbols, an ability of the UE to reliably receive PDCCH in an SBFD slot or symbol may be lost earlier than out-of-sync indications allow to detect. One consequence is loss of DL throughput due to the interruption and delay incurred by the gNB-side DL scheduling. For example, when using RLM-RS resources configured in a SBFD slot or symbol, an out-of-sync may be declared earlier than when evaluating RLM-RS resources in a normal DL slot where the UE experiences better Rx SINR conditions. When using only RLM-RS resources configured in SBFD slots or symbols, one consequence can be a premature declaration of RLF by the UE which results in an attempted RRC connection re-establishment procedure by the UE during which no data transmission/reception from/to the UE is possible at all, such as loss of data connectivity.

This disclosure also recognizes that for transmissions by a gNB in a full-duplex system, a different number of transmitter/receiver antennas, a different effective transmitter antenna aperture area, and/or different transmitter antenna directivity settings may be available for gNB transmissions in a DL slot or symbol, i.e., non-SBFD slot or symbol, when compared to gNB transmissions in a SBFD slot or symbol. Similar considerations may apply to gNB receptions by the gNB receiver in a normal UL slot or symbol when compared to gNB receptions in the UL sub-band of a SBFD slot. The EPRE settings of DL transmissions in a SBFD slot or symbol with full-duplex operation may be constrained to prevent gNB-side receiver AGC blocking and to enable effective implementation of serial interference cancellation (SIC) during receptions in the UL subband of the SBFD slot or symbol when comparted to the EPRE settings of DL transmissions in the normal DL slot.

Furthermore, this disclosure recognizes that interference levels experienced by the UE receiver may differ between DL receptions in a normal DL slot or symbol and DL receptions in a SBFD slot or symbol. During DL receptions in a normal DL slot, the UE receiver may be interfered by co-channel DL transmissions from neighbor gNBs. During DL receptions in an SBFD slot or symbol, the UE receiver may be subjected to UE-to-UE inter-subband co-channel and/or UE-to-UE adjacent channel cross-link interference (CLI) stemming from UL-to-DL transmissions in the SBFD slot or symbol.

This disclosure provides that a UE evaluates the out-of-sync and in-sync block error rates (BLER), BLERₒᵤₜ=10% and BLERᵢₙ=2%, respectively, for RLM according to BLER Configuration #0 as described in REF8. For example, for SSB-based radio link monitoring and out-of-sync evaluation to derive Q_{out_SSB}, the UE assumes a set of hypothetical PDCCH transmission parameters, i.e., DCI format 1_0, 2 CORESET symbols, AL-8, CORESET=24 PRBs, REG bundle size=6, PDCCH-to-SSS energy ratio=4 dB, PDCCH DMRS-to-SSS energy ratio=4 dB as tabulated in REF8. For SSB-based radio link monitoring and in-sync evaluation to derive Q_{in_SSB}, the UE assumes a different set of hypothetical PDCCH transmission parameters, i.e., DCI format 1_0, 2 CORESET symbols, AL=4, CORESET=24 PRBs, REG bundle size=6, PDCCH-to-SSS energy ratio=0 dB, PDCCH DMRS-to-SSS energy ratio=0 dB as tabulated in REF8. These hypothetical PDCCH transmission parameters represent the most challenging link conditions for the UE before the UE declares RLF, e.g., when reliable reception of even a small payload size of a scheduling DCI format is not meaningfully reliable. Similar considerations apply to CSI-RS based radio link monitoring and thresholds Q_{out_CSI-RS} and Q_{in_CSI-RS}.

Upon detection of a number (RRC counter N310) of consecutive “out-of-sync” indications and expiry of RRC timer T310, the UE considers radio link failure to be detected and attempts RRC connection re-establishment for a number of times. This disclosure notes that no data transmission/reception from/to the UE is then possible. If a number of random-access attempts by the UE fails, e.g., RRC connection re-establishment fails, the UE reverts back to RRC_IDLE mode.

For example, the UE evaluation of DL radio link quality can be configured using an RLM-RS resource, e.g., SSB, in a non-SBFD slot or symbol. The ability of the UE to reliably receive PDCCH in an SBFD slot or symbol may then be lost earlier than out-of-sync indications using the configured RLM-RS resources in the non-SBFD slot or symbols allow to detect. This is because the normal DL slots may benefit from higher DL Tx power and more favorable Tx antenna gains which result in more favorable Rx SINR conditions for the configured RLM-RS.

For example, the UE evaluation of DL radio link quality can be configured using an RLM-RS resource, e.g., 1-port CSI-RS with density=‘1’ or ‘3’, configured in a SBFD slot of symbol. Due to less DL Tx power and less favorable resulting Rx SINR conditions in a SBFD slot or symbol when compared to DL receptions of a same DL signal in a normal DL slot or symbol, out-of-sync may then be declared earlier than when evaluating the Rx SINR conditions in a normal DL slot. Using an RLM-RS resource in an SBFD slot or symbol, the UE may declare RLF failure and attempt RRC connection re-establishment earlier than necessary.

For example, multiple RLM-RS resources can be configured for a UE to evaluate radio link quality, e.g., using both SBFD and non-SBFD or normal DL slots or symbols. The UE physical layer then indicates, in frames where the radio link quality is assessed, out-of-sync to higher layers only when the radio link quality is evaluated worse than the threshold Qₒᵤₜ for all resources in the set of configured RLM-RS resources. However, out-of-sync for DL receptions of configured RLM-RS resources in a SBFD slot or symbol may occur at a different time, such as for example earlier than out-of-sync for DL receptions of configured RLM-RS resources in a normal DL slot due to less favorable Rx SINR conditions in the former. The ability of the UE to reliably receive PDCCH in an SBFD slot or symbol may then be lost already while in-sync indications by at least one resource in the set of configured RLM-RS resources, e.g., an RLM-RS resource configured in a normal DL slot or symbol.

For example, similar shortcomings as elaborated for the case of out-of-sync indications apply to the case of in-sync indications using multiple RLM-RS resources configured on both SBFD and non-SBFD or normal DL slots or symbols. This is because the UE physical layer indicates, in frames where the radio link quality is assessed, in-sync to higher layers when the radio link quality is better than the threshold Qᵢₙ for any resource in the set of RLM-RS resources.

A second issue is that evaluation of DL radio link quality using the configured RLM-RS resources only on a SBFD slot or symbol may result in undue operational constraints or may not be possible at all when gNB-side SBFD operation is enabled on legacy TDD flexible symbols or slots. That is undesirable because either gNB scheduling of UL transmission from the UE using the SBFD UL subband may be restricted in time-domain resulting in (a) a loss of UL coverage for the UE or (b) a reduced UL throughput in the full-duplex system. Also, the ability to evaluate RLM is lost for a UE configured with an UL subband in the SBFD slot or a UE may not be configurable to efficiently support gNB-side full-duplex operation by means of SRS transmissions for CLI estimation in such a slot. Additionally, a larger RS overhead would be required in order to also support RLM for UEs that do not support full-duplex operation. Similar considerations apply in case that evaluation of DL radio link quality using configured RLM-RS resources is restricted to be only on a DL slot or symbol. Further, an evaluation for RLM only in DL slots or symbols, or only in SBFD slots or symbols, may not reflect the link quality is SBFD slots or symbols, or in DL slots or symbols, respectively.

This disclosure recognizes that for a set of symbols of a slot that are indicated to a legacy UE as flexible (F symbols) by tdd-UL-DL-ConfigurationCommon, and tdd-UL-DL-ConfigurationDedicated if provided, a legacy UE does not expect to receive both dedicated higher layer parameters configuring transmission from the UE in the set of symbols of the slot and dedicated higher layer parameters configuring reception by the UE in the set of symbols of the slot. For operation on a single carrier in unpaired spectrum, if a legacy UE is configured by higher layers to receive a PDCCH, or a PDSCH, or a CSI-RS in a set of symbols of a slot, the UE receives the PDCCH, the PDSCH, or the CSI-RS if the UE does not detect a DCI format 0_0/0_1/1_0/1_1, or 2_3 that indicates to the UE to transmit a PUSCH, a PUCCH, a PRACH, or a SRS in at least one symbol of the set of symbols of the slot; otherwise, the UE does not receive the PDCCH, or the PDSCH, or the CSI-RS in the set of symbols of the slot.

For example, using existing technology, CSI-RS based radio link monitoring may be configured for the UE on a symbol in a flexible (F) slot but then no UL transmission in all other symbols of the flexible slot using the SBFD UL subband is possible for the UE. Supporting CSI-RS based radio link monitoring in a flexible slot may reduce the achievable UL throughput because the SBFD UL subband may not be scheduled for the UE in the flexible slot. Simultaneous higher layer configuration of reception of the CSI-RS for radio link monitoring by the UE and SRS transmission from the UE for UL channel sounding in a same slot is not supported. Simultaneous support by a UE for the RLM and CLI features in the SBFD slots then requires the use of multiple SBFD slots and the use of distinct and separate slots to configure the UE with the CSI-RS for RLM and the SRS for CLI, respectively. However, there are only few SBFD slots available in most practical and currently deployed legacy TDD UL-DL configurations, e.g., at most 3 using DXXXU.

This disclosure provides methods using multiple RLM-RS groups on a serving cell to separately evaluate and indicate out-of-sync or in-sync to higher layers for a group. The disclosure conceives methods whereby slot/symbol groups for radio link quality evaluation are configured for the UE. The disclosure conceives methods where separate parameterization for an RLM-RS group to evaluate radio link quality is provided to the UE including different sets of out-of-sync and in-sync block error rates, different sets of hypothetical PDCCH transmission parameters, or different determined or indicated respective evaluation periods. The disclosure further conceives methods to evaluate radio link quality for RS resources or RS resource indices of an RLM-RS group using adjustment or offset or scaling values with reference to RS resources or RS resource indices of another RLM-RS group. The disclosure also conceives methods where a UE indicates or signals radio link monitoring group failure or re-establishment indications to higher layers and/or the gNB.

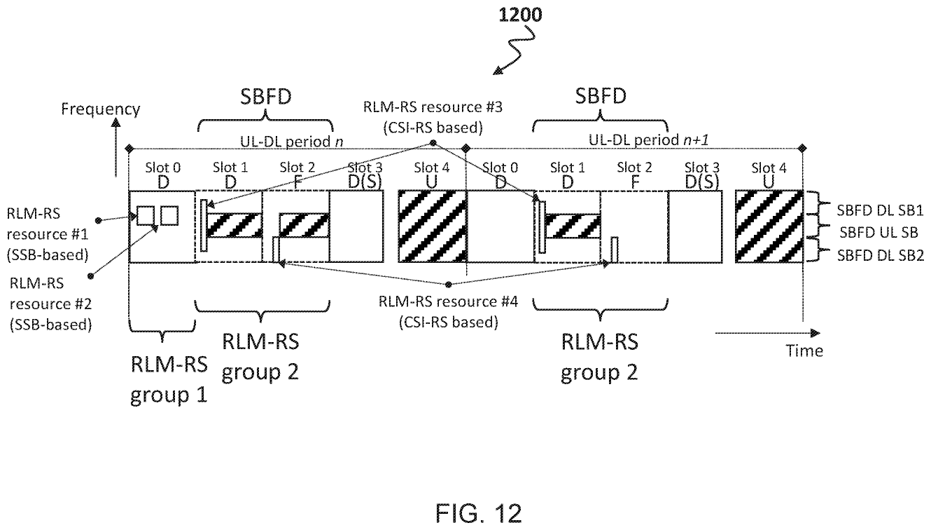

FIG. 12, illustrates an example diagram of a full-duplex communication system 1200 using two RLM-RS groups according to embodiments of this disclosure. The embodiment of a FD system 1200 using two RLM-RS groups illustrated in FIG. 12 is for illustration only. FIG. 12 does not limit the scope of this disclosure to any particular implementation of a FD communication system 1200 using two RLM-RS groups.

In one embodiment, a UE is provided multiple RLM-RS groups. The UE can be provided a set of reference signal (RS) resources or set of RS resource indices for each RLM-RS group. For example, the UE is provided a CSI-RS resource or CSI-RS resource index, or an SSB resource or SSB index, as RS resource or RS resource index for an RLM-RS group. An RLM-RS group is associated with a configurable set of time-domain resources, e.g., a set of slots or symbols in which a corresponding set of RS resources or of RS resource indexes are provided to the UE. A UE may also be provided by higher layers an association between slots or symbols for radio link quality evaluation and an RLM-RS group. Alternatively, an association between slots and symbols or an RLM-RS group may be indicated through the time-domain resource allocation of the RS resources or RS resource indices configured for an RLM-RS group.

A first RLM-RS group may be configured on non-SFBD slots or symbols. A second RLM-RS group may be configured on SFBD slots or symbols. The first RLM-RS group may be referred to as Primary RLM-RS group. The second RLM-RS group may be referred to as Secondary RLM-RS group. The UE performs radio link monitoring using the RS of an RLM-RS group for the associated time-domain resources, e.g., slots or symbols. When evaluating DL radio link quality, the UE indicates out-of-sync and in-sync, respectively, to higher layers for each RLM-RS group separately. The UE may indicate out-of-sync for one RLM-RS group while indicating in-sync for another RLM-RS group, or the UE may indicate in-sync for the two RLM-RS groups, or the UE may indicate that the two RLM-RS groups are out-of-sync.

For example, on each RLM-RS resource of an RLM-RS group, the UE may estimate the DL radio link quality and may compare it to the thresholds Qₒᵤₜ and Qᵢₙ for the purpose of monitoring DL radio link quality of the configured RLM-RS group and its associated time-domain resources in a cell. The physical layer in the UE indicates, in frames where the radio link quality is assessed, out-of-sync to higher layers for the time-domain resources associated with an RLM-RS group when the radio link quality is worse than the threshold Qₒᵤₜ for all resources in the set of resources of an RLM-RS group for radio link monitoring. When the radio link quality is better than the threshold Qᵢₙ for any resource in the set of resources of an RLM-RS group for radio link monitoring, the physical layer in the UE indicates, in frames where the radio link quality is assessed, in-sync to higher layers for the time-domain resources associated with an RLM-RS group.

For example, the first or primary RLM-RS group is configured with reference signals on non-SBFD slots or symbols and the second or secondary RLM-RS group is configured with reference signals in SBFD slots or symbols. The UE indicates out-of-sync for the first RLM-RS group when all RS associated with the first RLM-RS group indicate out-of-sync. The UE indicates in-sync for the first RLM-RS group when any RS associated with the first RLM-RS group indicates in-sync. The UE indicates out-of-sync for the second RLM-RS group when all RS associated with the second RLM-RS group indicate out-of-sync. The UE indicates in-sync for the second RLM-RS group when any RS associated with the second RLM-RS group indicates in-sync.

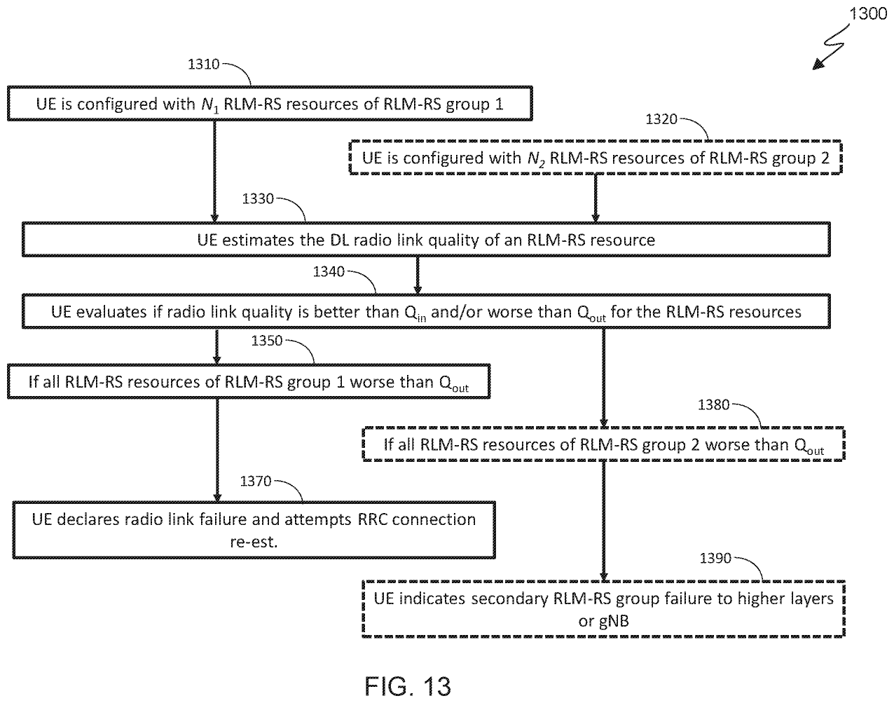

FIG. 13 illustrates an example process flowchart 1300 of a full-duplex communication system using two RLM-RS groups to evaluate radio link quality. The embodiment of a process flowchart 1300 of a FD communication system using two RLM-RS groups to evaluate radio link quality illustrated in FIG. 13 is for illustration only. FIG. 13 does not limit the scope of this disclosure to any particular implementation of a process flowchart for a FD communication system 1300 using two RLM-RS groups, and other implementations may be used without departing from the scope of this disclosure.

It is one advantage of this disclosure that the multiple RLM-RS groups can be configured for the UE to evaluate the radio link quality separately and to indicate the radio link quality separately to higher layers for the set of non-SBFD or normal DL slots or symbols, and the set of SBFD slots or symbols. For a secondary RLM-RS group configured on SBFD slots or symbols, the UE physical layer then indicates, in frames where the radio link quality is assessed, out-of-sync to higher layers only when the radio link quality is evaluated worse than the threshold Qₒᵤₜ for all RS resources in the set of configured RS resources in the secondary RLM-RS group on SBFD slots or symbols. Out-of-sync for DL receptions of configured resources of the Primary RLM-RS group on non-SBFD slot or symbols may occur at a different time, such as for example later than out-of-sync for DL receptions of configured resources in the Secondary RLM-RS group on SBFD slots due to more favorable Rx SINR conditions in the former group. Similar considerations apply to the ability of the UE to issue separate in-sync indications for the first and the second set of configured RLM-RS resources associated with the Primary and the Secondary RLM-RS group, respectively. It is another advantage that radio link failure or inability to receive at least an assumed small payload size for a reference DCI format with assumed hypothetical PDCCH transmission parameters is separately reportable to UE higher layers or the gNB. Out-of-sync for the Secondary RLM-RS group on SBFD slots or symbols can be detected and indicated by the UE physical layer to higher layers and can be reported separately to the gNB.

The UE determines first and second RLM-RS groups. RLM-RS₁ and RLM-RS₂, for radio link monitoring in a serving cell. The first RLM-RS group RLM-RS₁ for a serving cell is associated with RS(s) configured for the UE in a first set of slots or symbols of the serving cell, such as in non-SBFD slots or symbols. The second RLM-RS group RLM-RS₂ for a serving cell is associated with RS(s) configured for the UE in a second set of slots or symbols on the serving cell, such as in SBFD slots or symbols. On the RLM-RS resource(s) in an RLM-RS group, the UE estimates the DL radio link quality and compares it to the thresholds Qₒᵤₜ and Qᵢₙ for the purpose of monitoring DL radio link quality of the cell in one or multiple slots or symbols. The UE evaluation of the radio link quality thresholds Qₒᵤₜ and Qᵢₙ, may account for an evaluation or indication period. The length, duration or criteria associated with an evaluation or indication period for the first and second RLM-RS group, RLM-RS₁ and RLM-RS₂, respectively, may be indicated or specified by same parameters or by separate parameters.

A first RLM-RS group and a second RLM-RS group, RLM-RS₁ and RLM-RS₂ respectively, associated with RS(s) in different RLM-RS slot/symbol groups may be provided to the UE by one or a combination of RRC signaling and/or configuration, MAC CE signaling. L1 control signaling by DCI, or tabulated and/or listed by system operating specifications.

It is also possible that only a first RLM-RS group RLM-RS₁ associated with a first set of time-domain resources, e.g., slots or symbols, is provided to the UE by RRC whereas the UE determines a second RLM-RS group RLM-RS₂ associated with a second set of time-domain resources, e.g., slots or symbols, from, e.g., L1 control signaling by DCI. The determination of a second RLM-RS group RLM-RS₂ associated with a second set of time-domain resources, e.g., slots or symbols, may depend on and be a function of a first provided RLM-RS group RLM-RS₁. For example, the UE may determine some or all RS resources or RS resource indices for RLM-RS₂ as a set of RS resources or RS resource indices configured with respect to or as function of a set of RS resources or RS resources indices configured for RLM-RS₁.

The sets of RS resources in a first RLM-RS group and a second RLM-RS group, RLM-RS₁ and RLM-RS₂ respectively, on a serving cell may be provided to or determined by the UE by means of RS resource indices. For example, a RS resource index may correspond to an SSB index, or a CSI-RS resource index, or a TCI state for PDCCH reception that includes one or more CSI-RS.

For example, the RS resources or RS resource indices of the first RLM-RS group or second RLM-RS group may be included in one or more signaling messages and/or IEs. For example, and without loss of generality, the gNB may provide these to the UE as part of RRC signaling messages of type RRCSetup, RRCReconfiguration, SIB1 or SystemInformation and or may provide such configuration in RRC IEs of type ServingCellConfig, ServingCellConfigCommon, or ServingCellConfigSIB1 where an RRC configuration parameter may be of enumerated, listed or sequence type, and/or may be encoded as a bit string.

For the first and second RLM-RS groups on a serving cell, RLM-RS₁ and RLM-RS₂ respectively, the UE may be provided up to N_{LR-RLM} RadioLinkMonitoringRS for link recovery procedures and for radio link monitoring. For the first and second RLM-RS groups, RLM-RS₁ and RLM-RS₂ respectively, on a serving cell, the UE may be provided up to N_{LR-RLM.1} RadioLinkMonitoringRS for the first RLM-RS group RLM-RS₁ and up to N_{LR-RLM.2} RadioLinkMonitoringRS for the second RLM-RS group RLM-RS₂, for link recovery procedures and for radio link monitoring. For example, N_{LR-RLM.1}+N_{LR-RLM.2}=N_{LR-RLM}. A maximum value of N_{LR-RLM} can be same as for a UE not supporting full-duplex/SBFD operation or a new UE capability can be defined and a maximum value of N_{LR-RLM} can be larger for a UE supporting full-duplex/SBFD operation than for a UE not supporting full-duplex/SBFD operation. From the N_{LR-RLM} RadioLinkMonitoringRS, up to N_{RLM} RadioLinkMonitoringRS can be used for radio link monitoring depending on L_{MAX} as described in REF3, and up to two RadioLinkMonitoringRS can be used for link recovery procedures.

For radio link monitoring using the RS of a first RLM-RS group or a second RLM-RS group on a serving cell, RLM-RS₁ or RLM-RS₂, respectively, up to N_{RLM.1} RadioLinkMonitoringRS and up to N_{RLM.2} RadioLinkMonitoringRS can be used, respectively. For example, N_{RLM.1}+N_{RLM.2}=N_{RLM}. The UE monitors up to N_{RLM.1} RLM-RS resources for the first RLM-RS group, or up to N_{RLM.2} RLM-RS resources for the second RLM-RS group, in each corresponding carrier frequency range depending on a maximum number Lₘₐₓ of candidate SSBs per half frame.

The UE may determine the DL radio link quality DL receptions in a slot or symbol using either the first RLM-RS group or the second RLM-RS group, RLM-RS₁ or RLM-RS₂, respectively. A first RLM-RS group RLM-RS₁ may be used by the UE to determine DL reception quality in a normal DL slot or symbol, e.g., non-SBFD slots or symbols. A second RLM-RS group RLM-RS₂ may be used by the UE to determine DL reception quality in a full-duplex/SBFD slot or symbol.

The UE may determine the DL reception quality in a slot or symbol using a same RS resource or RS resource index configured in both the first and the second RLM-RS groups RLM-RS₁ and RLM-RS₂. A signaling condition or priority rules may then be used by the UE to include the same RS resource or RS resource index in a particular occurrence, e.g., slot or symbol, in the radio link quality evaluation.

For example, a same RS resource or RS resource index associated with a first RLM-RS group and a second RLM-RS group may be configured on a flexible slot or symbol. When the UE determines the flexible slot or symbol to be scheduled or configured by the gNB for DL-only transmissions, the UE includes the same RS resource or RS resource index as part of the radio link quality evaluation for the first or Primary RLM-RS group, e.g., on non-full-duplex or non-SBFD slots or symbols. When the UE determines the flexible slot or symbol to be scheduled or configured by the gNB for DL and UL transmissions, e.g., the flexible slot or symbol is used by the gNB for full-duplex or SBFD transmissions and receptions, the UE includes the same RS resource or RS resource index as part of the radio link quality evaluation for the second or Secondary RLM-RS group, e.g., on full-duplex or SBFD slots or symbols. When the UE receives a DCI format scheduling transmission or reception on a slot or symbol, the UE selects an RLM-RS group to determine the radio link quality using the associated RS resource or RS resource index of the RLM-RS in that slot or symbol.

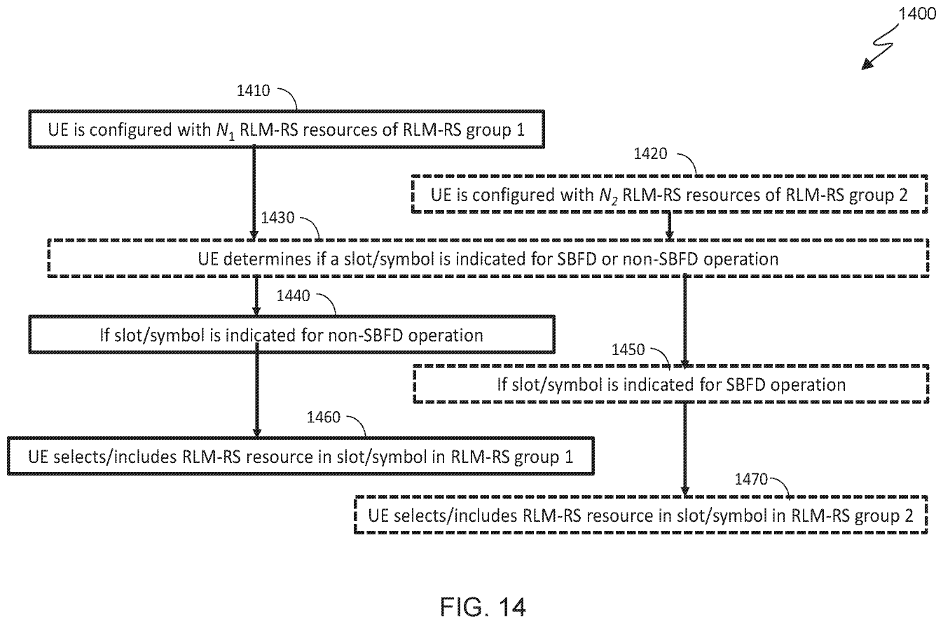

FIG. 14 illustrates an example process flowchart 1400 of a full-duplex communication system using two RLM-RS groups to select an RLM-RS group according to embodiments of this disclosure. The embodiment of the example process flowchart 1400 illustrated in FIG. 14 is for illustration only. FIG. 14 does not limit the scope of this disclosure to any particular implementation of the example process flowchart 1400 of a FD communication system using two RLM-RS groups to select an RLM-RS group.

For example, the UE selects an RLM-RS group associated with radio link quality evaluation in a slot or symbol based on a slot or symbol type in a time period. The slot type may include one or a combination of the following:
slot or symbol of type D (Downlink), U (Uplink) or F (Flexible) in a TDD common or dedicated UL-DL frame configuration or provided through SFI such as in DCI format 2_0;
slot or symbol of type ‘simultaneous Tx-Rx’, ‘Rx only’, or ‘Tx only’, e.g., associated with a cell common or a UE dedicated slot and/or symbol configuration providing a resource or transmission type indication; or
slot or symbol associated with a full-duplex UL transmission resource or SBFD UL subband configuration or a full-duplex DL transmission resource or SBFD DL subband configuration; or
slot or symbol assignment provided to the UE by DCI scheduling.

For example, the UE selects an RLM-RS group RLM-RS for radio link quality monitoring evaluation using a configured RS resource or RS resource index in a slot or symbol that is provided, for example, by a higher layer parameter in fd-config. The UE determines the resource type configuration of a serving cell by receiving a system information block (SIB), such as a SIB1, or by a common RRC signaling, or by UE-specific RRC signaling. For example, the resource type indication provided to the UE by higher layers indicates that a slot or symbol or symbol group of the transmission resource may be of type ‘simultaneous Tx-Rx’, ‘Rx only’, or ‘Tx only’. For example, a transmission resource of type ‘simultaneous Tx-Rx’, ‘Rx only’, or ‘Tx only’ can be provided per slot type ‘D’, ‘U’ or ‘F’ in a slot. For example, the transmission resource may be configured with an SBFD UL and/or DL subband. The indication of the resource type may be provided independently of the transmission direction of a slot or symbol indicated to the UE by the TDD UL-DL frame configuration provided by higher layers. If the determined slot or symbol type of a slot or symbol for radio link quality evaluation is ‘non-SBFD’, the UE selects a first RLM-RS group RLM-RS₁. If the determined slot or symbol type of a slot or symbol for radio link quality evaluation is ‘SBFD’, the UE selects the second RLM-RS group RLM-RS₂. A motivation is that by determining a slot or symbol as type ‘non-SBFD’ versus ‘SBFD’, the UE may distinguish between slots or symbols in which the UE may assume that only UL transmissions occur versus slots where the UE cannot make any assumption of the DL and/or UL scheduling decisions by the gNB. Accordingly, the UE can select and use the more conservative RLM-RS group RLM-RS₂ for the full-duplex or SBFD slot or symbol, if indicated. After the UE selects an RLM-RS group RLM-RSₖ in a slot or symbol for radio link quality evaluation, the UE applies an in-sync and/or out-of-sync criterion for the configured RLM-RS group RLM-RSₖ to determine if an in-sync or out-of-sync indication for an RLM-RS resource in that slot or symbol should be indicated to higher layers.

In more embodiments, the first and second set of slots or symbols of the serving cell associated with a first RLM-RS group and a second RLM-RS group, RLM-RS₁ and RLM-RS₂, for radio link monitoring may be configured as a first RLM-RS Slot or Symbol Group MSG1 and a second RLM-RS Slot or Symbol Group MSG2, respectively. A UE may be configured with one or more RLM-RS Slot or Symbol Group(s) (MSG(s)) for radio link quality evaluation on a serving cell where an MSG is a set of slots or symbols of the serving cell associated with a same signaled RLM-RS group or a same set of RS resources or RS resource indices. A UE may select an RLM-RS group associated with radio link quality monitoring in a slot or symbol by determining a slot or symbol type, or by determining presence/absence or configuration of an SBFD subband allocation, or by DCI-based scheduling.

For example, the association between slots or symbols for radio link quality evaluation and an RLM-RS group, e.g., MSG, may be indicated to the UE using a list or a bitmap indicating applicable or valid, or not applicable or not valid, symbols or slots for the MSG. An MSG may include only a single slot or symbol, or the MSG may comprise all slots or all symbols in a period. There may be only a single or a default MSG. The MSG may comprise a default RS resource or RS resource index set such as the indicated SSB indices of the serving cell. When an MSG includes more than one slot or symbol, the slots or symbols of the MSG can be consecutive, or they can be non-consecutive. One or multiple MSGs may be configured for the UE.

For example, a UE can be indicated a first MSG containing a normal DL slot or symbol, e.g., non-full-duplex or non-SBFD slot or symbol and a second MSG containing a full-duplex or SBFD slot or symbol. When an RLM-RS group RLM-RSₖ is determined by or provided to the UE for an MSGₖ, the UE applies the value RLM-RSₖ to determine the radio link monitoring parameters for a slot or symbol in MSGₖ. The UE does not apply the RLM-RS group RLM-RSₖ to determine the associated radio link monitoring parameters in a slot or symbol when the slot or symbol is not part of the MSGₖ. One or multiple RLM-RS groups RLM-RSₖ may be associated with an MSG, e.g., one or more values RLM-RSₖ may be determined by or provided to the UE. When an MSG is associated with multiple RLM-RS groups, the UE determines an RLM-RS group RLM-RSₖ for the slot or symbol from the set of determined or provided RLM-RS groups associated with the MSG by selecting a value RLM-RSₖ according to an applicable rule, e.g., slot type, configuration SBFD subband transmission direction, a priority level, or the order or sequence in which values are determined by or provided to the UE. A priority level, or the order or sequence in which RLM-RS groups or MSGs are determined by or provided to the UE.

A UE can be provided a higher layer parameter indicating the slot or symbol association for an RLM-RS Slot or Symbol Group by RRC signaling messages and IEs. For example, and without loss of generality, an RRC parameter or field may be signaled from the gNB to the UE as part of RRC signaling messages of type RRCSetup, RRCReconfiguration, SIB1 or SystemInformation and may be included in RRC IEs of type ServingCellConfig, ServingCellConfigCommon, or ServingCellConfigSIB1. These configuration parameters may be of enumerated, listed or sequence type, and/or may be encoded as a bit string.

For example, a configuration for a slot or symbol association for an RLM-RS Slot or Symbol Group may be provided as SEQUENCE (SIZE (1, . . . , maxNrofMSGs)) OF Msg where ‘Msg’ is a bit string of size M. For example, M=10 or a multiple thereof. When Msg={0011000000}, the 3^{rd} and 4^{th} slot or slot #2 and #3 in a sequence of 10 slots numbered from 0 to 9 are configured as part of the RLM-RS slot group RLM-RS. When Msg={0000000011}, slots #8-#9 in a sequence of 10 slots are configured as part of the RLM-RS slot group RLM-RS, etc.

In some embodiments, the sets of RS resources or RS resource indices associated with a first RLM-RS group and a second RLM-RS group are associated with separate parameters rlmInSyncOutOfSyncThreshold. The sets of RS resources or RS resource indices associated with a first RLM-RS group and a second RLM-RS group can also be separately indicated or specified for corresponding out-of-sync and in-sync block error rates.

For example, a first RLM-RS group may be configured on non-SFBD slots or symbols. A second RLM-RS group may be configured on SFBD slots or symbols. The UE is indicated by higher layers a first out-of-sync block error rate (BLER_{out.1}) and a first in-sync block error rate (BLER_{in.1}) via parameter rlmInSyncOutOfSyncThreshold₁ for the RS resource or RS resource indices of the first RLM-RS group. The UE is indicated by higher layers a second out-of-sync block error rate (BLER_{out.2}) and a second in-sync block error rate (BLER_{in.2}) via parameter rlmInSyncOutOfSyncThreshold₂ for the RS resources or RS resource indices of the second RLM-RS group. When a UE is not provided rlmInSyncOutOfSyncThreshold₁ or rlmInSyncOutOfSyncThreshold₂ from the network, the UE may determine corresponding out-of-sync and in-sync block error rates from a default configuration. For example, the UE may evaluate the out-of-sync and in-sync block error rates BLER_{out.1}=8% and BLER_{in.1}=1%, BLER_{out.2}=10% and BLER_{in.2}=2%, respectively, for RLM in non-full-duplex slots and in full-duplex slots, respectively.

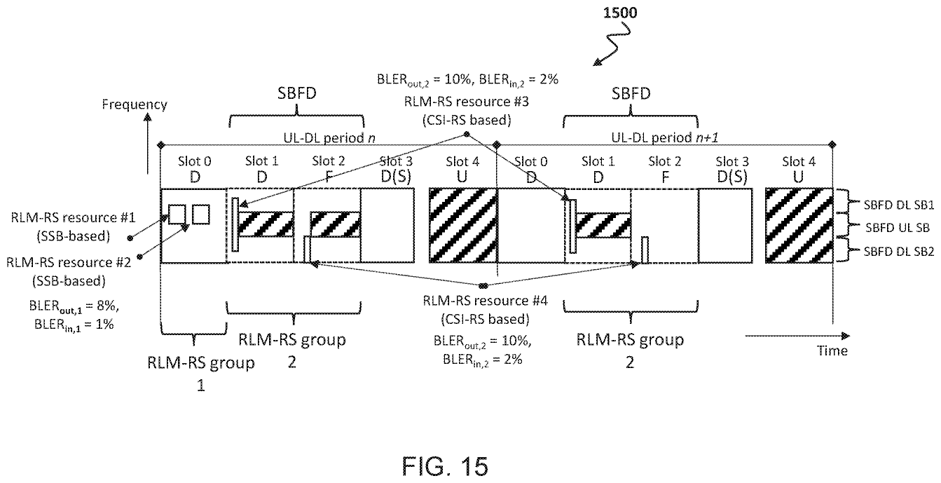

FIG. 15 illustrates an example diagram of a full-duplex communication system 1500 using two RLM-RS groups configured with different out-of-sync and in-sync block error rates in accordance with embodiments of this disclosure. The FD communication system 1500 using two RLM-RS groups configured with different out-of-sync and in-sync block error rates illustrated in FIG. 15 is for illustration only. FIG. 15 does not limit the scope of this disclosure to any particular implementation of the FD communication system 1500 using two RLM-RS groups configured with different out-of-sync and in-sync block error rates.

It is one advantage of this disclosure that distinct BLER targets for a hypothetical PDCCH transmission can be indicated for the UE to evaluate the radio link quality separately and to indicate the radio link quality separately to higher layers for the set of non-full-duplex or normal DL slots or symbols, and the set of SBFD slots or symbols. In the SBFD slots or symbols where more CLI is potentially incurred from co-scheduled UEs on a same transmission resource, more aggressive BLER targets can be set by the network to adjust for the higher variability in DL link conditions of the victim UE receiving DL transmissions in a SBFD DL subband during system operation.

In other embodiments, the sets of RS resources or RS resource indices associated with a first RLM-RS group and a second RLM-RS group are associated with separate sets of hypothetical PDCCH transmission parameters. Parameters associated with a hypothetical PDCCH transmission may include a DCI format and/or a DCI format size, a number of CORESET symbols, a CCE aggregation level, an EPRE value or power ratio such as between PDCCH RE energy and SSS energy or between PDCCH DMRS energy and SSS RE energy, a CORESET bandwidth such as number of PRBs for the CORESET, an SCS, a DMRS precoder granularity, a REG bundle size, a CP length, or a REG-to-CCE mapping. Parameters associated with a hypothetical PDCCH transmission for a first RLM-RS group and a second RLM-RS group may be provided/determined separately for out-of-sync evaluation or may be provided/determined separately for in-sync evaluation. Some or all parameters associated with a hypothetical PDCCH transmission to evaluate out-of-sync and in-sync may be configured the same.

For example, a first RLM-RS group may be configured on non-SFBD slots or symbols. A second RLM-RS group may be configured on SFBD slots or symbols. The UE may be indicated, specified, or determine a first hypothetical PDCCH transmission parameter set for SSB-based radio link monitoring and out-of-sync evaluation to derive Q_{out_SSB} for the first RLM-RS group in non-SBFD symbols, e.g., DCI format 1_0, 2 CORESET symbols, AL=8, CORESET=24 PRBs, REG bundle size=6, PDCCH-to-SSS energy ratio=4 dB, PDCCH DMRS-to-SSS energy ratio=4 dB. The UE may be indicated, specified, or determine a second hypothetical PDCCH transmission parameter set for CSI-RS based radio link monitoring and out-of-sync evaluation to derive Q_{out_CSI-RS} for the second RLM-RS group in SBFD symbols, e.g., DCI format 1_0, 1 CORESET symbol, AL-4, CORESET=48 PRBs, REG bundle size=6, PDCCH-to-SSS energy ratio=0 dB, PDCCH DMRS-to-SSS energy ratio=0 dB. In this example and for simplicity, a same set of hypothetical PDCCH transmission parameters for radio link monitoring and in-sync evaluation may be assumed and configured for the first RLM-RS group and the second RLM-RS group.

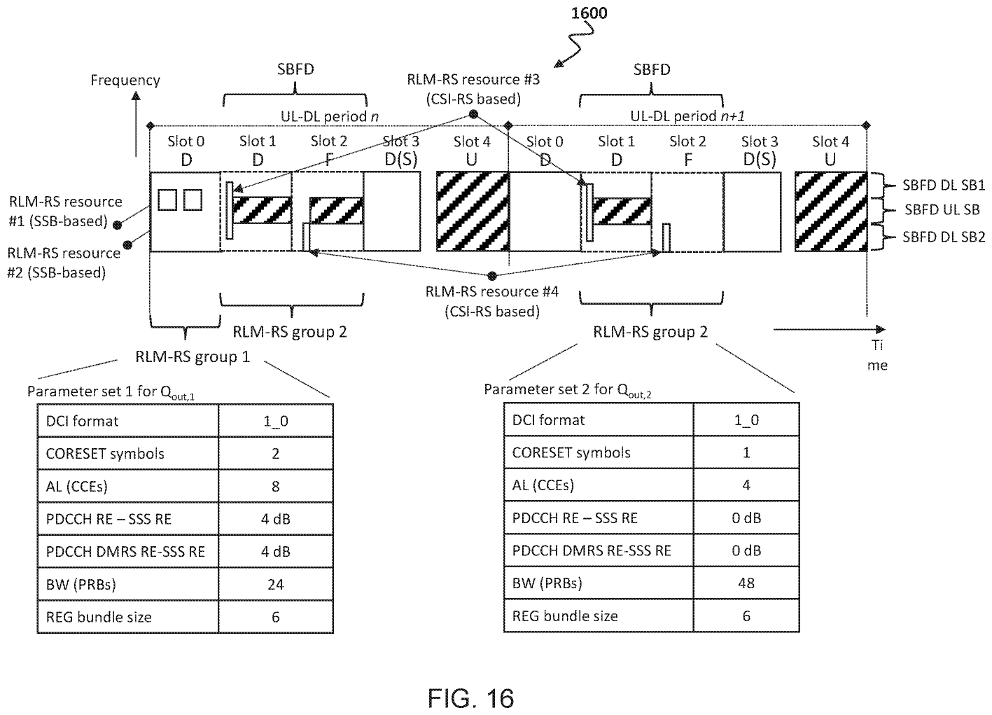

FIG. 16 illustrates an example diagram of a full-duplex communication system 1600 using two RLM-RS groups configured with different parameter sets in accordance with embodiments of this disclosure. The embodiments of the FD communication system 1600 using two RLM-RS groups configured with different parameter sets illustrated in FIG. 16 is for illustration only. FIG. 16 does not limit the scope of this disclosure to any particular implementation of the FD communication system 1600 using two RLM-RS groups configured with different out-of-sync and in-sync block error rates.

It is another advantage of this disclosure that assumed or hypothetical PDCCH transmission parameter sets can be indicated, specified, or determined for a UE to adjust the radio link quality evaluation to the needs and specifics of the SBFD DL or UL subband configuration. The radio link quality can be indicated separately to higher layers for the set of non-full-duplex or normal DL slots or symbols and the set of SBFD slots or symbols. The UE can evaluate and indicate the radio link quality using typical or expected PDCCH configurations in the SBFD slots or symbols.

In further embodiments, a UE evaluates the sets of RS resources or RS resource indices associated with a first RLM-RS group and a second RLM-RS group using separately determined/indicated respective evaluation periods T_{Evaluate_out} and/or T_{Evaluate_in}. Evaluation periods and adjustment factors applied to a first RLM-RS group and a second RLM-RS group may account for presence/absence of non-SBFD/SBFD slots. For example, an evaluation period for a first RLM-RS group may be increased or scaled by accounting or adjusting for a number of SBFD slots or symbols during a time period. For example, an evaluation period for a second RLM-RS group may be decreased or scaled by accounting or adjusting for a number of non-SBFD slots during a time period.

For example, a first RLM-RS group may be configured on non-SFBD slots or symbols. A second RLM-RS group may be configured on SFBD slots or symbols. The UE evaluates whether the DL radio link quality on the configured RLM-RS resource of the first RLM-RS group estimated over the last T_{Evaluate_out.1} [msec] period becomes worse than the threshold Q_{out.1} within T_{Evaluate_out.1} [msec] evaluation period. The UE evaluates whether the DL radio link quality on the configured RLM-RS resource of the first RLM-RS group estimated over the last T_{Evaluate_in.1} [msec] period becomes better than the threshold Q_{in.1} within T_{Evaluate_in.1} [msec] evaluation period. The UE evaluates whether the DL radio link quality on the configured RLM-RS resource of the second RLM-RS group estimated over the last T_{Evaluate_out.2} [msec] period becomes worse than the threshold Q_{out.2} within T_{Evaluate_out.2} [msec] evaluation period. The UE evaluates whether the DL radio link quality on the configured RLM-RS resource of the second RLM-RS group estimated over the last T_{Evaluate_in.2} [msec] period becomes better than the threshold Q_{in.2} within T_{Evaluate_in.2} [msec] evaluation period. For example, in the case of no DRX, T_{Evaluate_out.1}=200 ms and T_{Evaluate_out.2}=300 ms, T_{Evaluate_in.1}=100 ms and T_{Evaluate_in.2}=150 ms.

It is yet another advantage of this disclosure that the evaluation period for the SBFD slots or symbols can be selected and indicated/determined separately from the evaluation period for non-full-duplex slots. For example, the primary RLM-RS group, e.g., using SSB-based RLM in a legacy DL slot, may use legacy NR settings and parameters T_{Evaluate_out.1}=200 ms and T_{Evaluate_out.2}=100 msec for which DL link robustness is managed by the network. The secondary RLM-RS group, e.g., using CSI-RS based RLM in SBFD slots may use larger indication latency settings to allow for more signal power and interference variations before out-of-sync is declared by the UE in the SBFD resources.

In some embodiments, a UE evaluates the sets of RS resources or RS resource indices associated with a second RLM-RS group using an adjustment or offset or scaling value with reference to a first RLM-RS group that can be indicated to the UE by higher layers.

The UE applies the Qₒᵤₜ or Qᵢₙ threshold(s) of a second RLM-RS group to the RSRP/RSRQ measurement(s) obtained for an SSB-based or CSI-RS based resource of a first RLM-RS group after scaling a respective SSB or CSI-RS reception power with an adjustment or offset or scaling value for an RLM-RS resource configured in an SBFD slot or symbol. Different adjustment or offset or scaling value(s) may be provided to the UE for the Qₒᵤₜ or Qᵢₙ threshold(s). Multiple adjustment or offset or scaling value(s) may be provided to the UE for the Qₒᵤₜ and Qᵢₙ threshold(s), respectively. A specified default adjustment or offset or scaling value may be assumed by the UE when a corresponding indication is not provided to the UE by higher layers.

For example, a first RLM-RS group may be configured on non-SFBD slots or symbols. A second RLM-RS group may be configured on SFBD slots or symbols. The UE is provided with an adjustment value Delta_{OOS}=−6 dB by higher layers for the RS resources or RS resource indices of the second RLM-RS group for out-of-sync evaluation. The UE is provided with an adjustment value Delta_{1S}=+3 dB by higher layers for the RS resources or RS resource indices of the second RLM-RS group for in-sync evaluation. The UE measures RSRP/RSRQ for an SSB-based RS of the first RLM-RS group to evaluate if the out-of-sync criterion is met. The UE uses the RSRP/RSRQ measurement and applies the configured Delta_{OOS} adjustment value to determine if the out-of-sync criterion for a RS of the second RLM-RS group is met, e.g., the UE scales a respective SSB or CSI-RS reception power with an adjustment or offset or scaling value for an RLM-RS resource configured in an SBFD slot or symbol. The UE uses the RSRP/RSRQ measurement and applies the configured Delta_{1S} adjustment value to determine if the in-sync criterion for a RS of the second RLM-RS group is met.

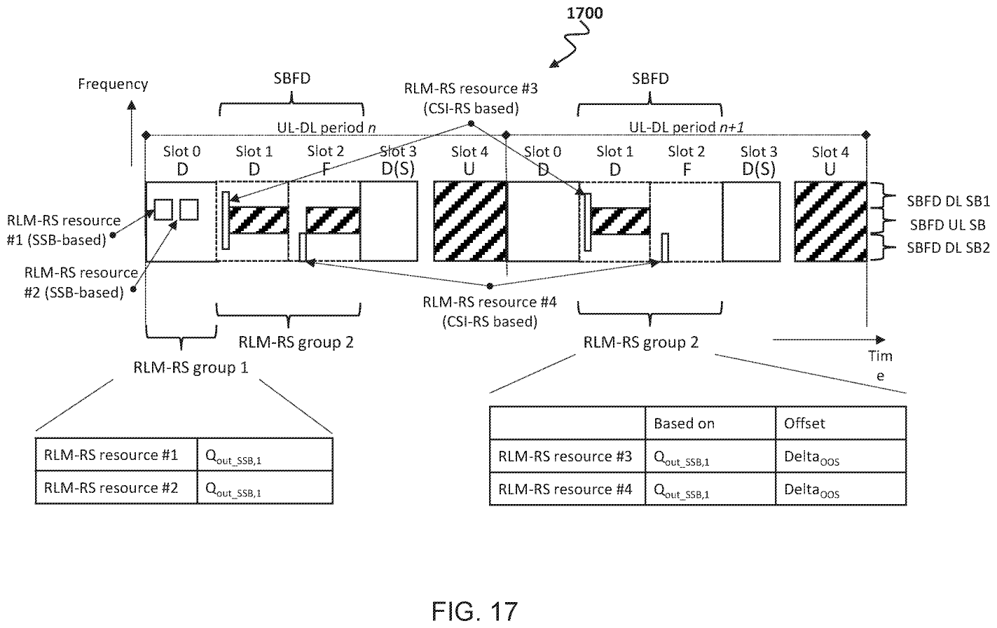

FIG. 17 illustrates an example diagram of a full-duplex communication system 1700 using two RLM-RS groups configured with an adjustment or offset value in accordance with embodiments of this disclosure. The full-duplex communication system 1700 using two RLM-RS groups configured with an adjustment or offset value illustrated in FIG. 17 is for illustration only. FIG. 17 does not limit the scope of this disclosure to any particular implementation of the full-duplex communication system 1700 using two RLM-RS groups configured with an adjustment or offset value.

It is another advantage of this disclosure that radio link quality evaluation can be configured for the UE to account for a single assumed link degradation factor when comparing DL receptions in non-SBFD and SBFD slots. When the number of more available DL TRX for DL transmissions using a normal DL slot and the number of fewer DL TRX for DL transmissions using the DL subbands of an SBFD slot are known and other antenna panel design parameters are accounted for, the difference for radio link quality evaluation can be estimated by the network implementation and be provided as single offset or adjustment value to balance the expected RLM behavior for the non-SBFD and SBFD slots. UE complexity to implement radio link quality evaluation in a full-duplex system is reduced.

In embodiments, the UE signals a secondary radio link monitoring group failure indication to higher layers and/or the gNB using UL signaling when all RS resources configured in a set of RS resources or RS resource indices of a second RLM-RS group indicate out-of-sync. The UE signals a secondary radio link monitoring group re-establishment indication to higher layers and/or the gNB using UL signaling when any RS resource configured in a set of RS resources or RS resource indices of a second RLM-RS group indicates in-sync.

For example, the first or Primary RLM-RS group is configured with RS resources in non-SBFD slots or symbols and the second or Secondary RLM-RS group is configured with RS resources in SBFD slots or symbols. On each RLM-RS resource of an RLM-RS group, the UE may estimate the DL radio link quality and may compare it to the thresholds Qₒᵤₜ and Qᵢₙ for the purpose of monitoring DL radio link quality of the configured RLM-RS group and its associated time-domain resources in a cell. The physical layer in the UE indicates, in frames where the radio link quality is assessed, out-of-sync to higher layers for the time-domain resources associated with an RLM-RS group when the radio link quality is worse than the threshold Qₒᵤₜ for all resources in the set of resources of an RLM-RS group for radio link monitoring. When the radio link quality is better than the threshold Qᵢₙ for any resource in the set of resources of an RLM-RS group for radio link monitoring, the physical layer in the UE indicates, in frames where the radio link quality is assessed, in-sync to higher layers for the time-domain resources associated with an RLM-RS group. For a Secondary RLM-RS group for radio link monitoring, the UE transmits a secondary radio link monitoring group failure indication in the UL using PUCCH, PUSCH, RACH or SRS, when the radio link quality is worse than the threshold Qₒᵤₜ for all resources in the set of resources of the Secondary RLM-RS group. For a Secondary RLM-RS group for radio link monitoring, the UE may transmit a secondary radio link monitoring group re-establishment indication in the UL using PUCCH, PUSCH, RACH or SRS, when the radio link quality is better than the threshold Qᵢₙ for any resources in the set of resources of the Secondary RLM-RS group. The UE does not initiate the RRC re-establishment procedure when out-of-sync is indicated for all RS resources or RS resource indices associated with the secondary RLM-RS group. For example, the UE may initiate fallback operation, e.g., continue using only a limited set of DL/UL radio resources such as those associated with the Primary RLM-RS group if the Primary RLM-RS indicates in-sync. When out-of-sync is indicated by the UE to higher layers for the Primary RLM-RS group, the UE considers radio link failure to be detected, and attempts RRC connection re-establishment. Different counter and timer values may be associated with the first and the second RLM-RS groups. For example, the first or Primary RLM-RS group may be configured with RRC counter N310 or RRC timer T310 values, e.g., follow radio link failure detection procedures. The second or Secondary RLM-RS group may be configured with other, possibly distinct, RRC counter or RRC timer values to determine the amount of time and number of occurrences before the UE transmits the radio link monitoring group failure or re-establishment indication(s).

A UE may indicate a radio link monitoring group failure or re-establishment indication for an RLM-RS group using one or a combination of RRC signaling, MAC CE signaling, or L1 control signaling. The UE may indicate a radio link monitoring group failure or re-establishment indication using PUCCH, PUSCH, RACH or SRS.

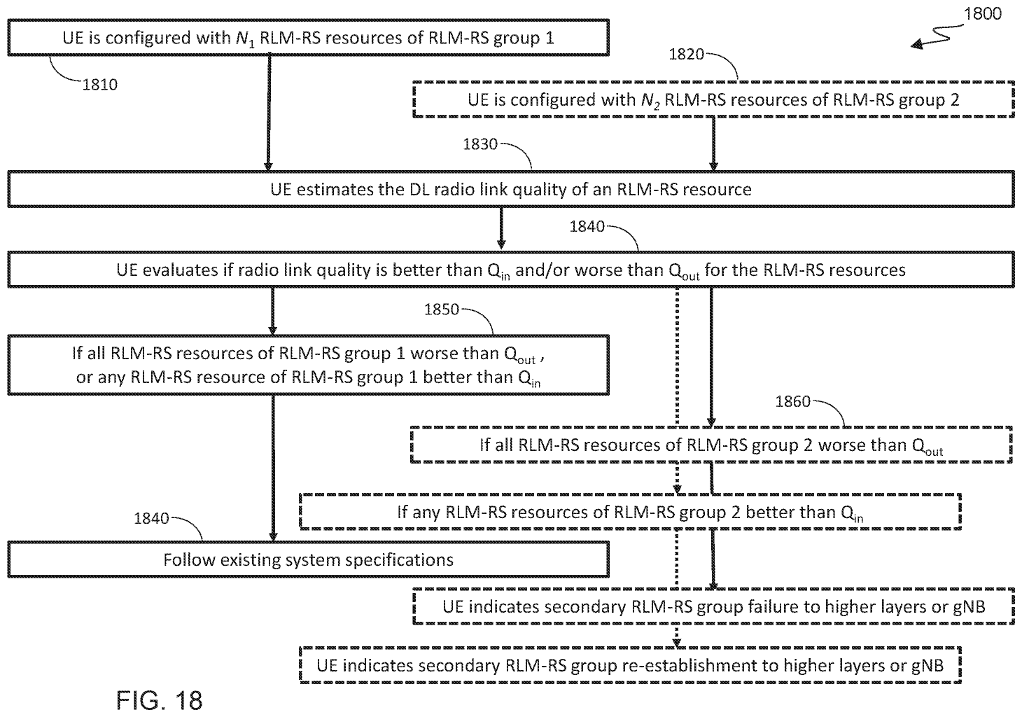

FIG. 18 illustrates an example process flowchart 1800 of a full-duplex communication system using two RLM-RS groups to indicate radio link monitoring group failure or re-establishment. The example process flowchart 1800 of a full-duplex communication system using two RLM-RS groups to indicate radio link monitoring group failure or re-establishment illustrated in FIG. 18 is for illustration only. FIG. 18 does not limit the scope of this disclosure to any particular implementation of the example process flowchart 1800 of a full-duplex communication system using two RLM-RS groups to indicate radio link monitoring group failure or re-establishment.

It is yet another advantage of this disclosure that out-of-sync and in-sync for the Secondary RLM-RS group on full-duplex or SBFD slots or symbols can be detected and indicated by the UE physical layer to higher layers and can be reported separately to the gNB. The gNB may then apply necessary actions, e.g., DL/UL scheduling may still be possible on a limited set of non-SBFD slots or symbols while the Primary RLM-RS group indicates in-sync due to more favorable Rx SINR conditions. The UE may not need to initiate RRC connection re-establishment procedures while the Primary RLM-RS group indicates in-sync, and the DL/UL data scheduling does not need to be interrupted.

What is claimed is:

1. A method of operating a user equipment (UE), the method comprising:
receiving first information for a first set of radio link monitoring (RLM) reference signals (RSs) and a first set of parameters associated with an evaluation of the first set of RLM RSs, wherein the first set of RLM RSs corresponds to a first subset of slots from a set of slots on a cell;
receiving second information for a second set of RLM RSs and a second set of parameters associated with an evaluation of the second set of RLM RSs, wherein the second set of RLM RSS corresponds to a second subset of slots from the set of slots on the cell;
determining, based on the first set of parameters, a first reception quality for the first set of RLM RSS;
determining a radio link failure for the first subset of slots when a reception quality of any RLM RS from the first set of RLM RSs is below a first reception quality threshold for a first time period;
determining, based on the second set of parameters, a second reception quality for the second set of RLM RSs; and
determining a radio link failure for the second subset of slots when a reception quality of any RLM RS from the second set of RLM RSs is below a second reception quality threshold for a second time period,
wherein:
the first subset of slots does not include time-domain resources indicated for simultaneous transmission and reception on the cell, and
the second subset of slots includes time-domain resources indicated for simultaneous transmission and reception on the cell.

2. The method of claim 1, further comprising determining a radio link failure for the cell based on the determination for the radio link failure for the first subset of slots and for the radio link failure the second subset of slots.

3. The method of claim 1, further comprising:
determining a secondary radio link failure based on the determination for the radio link failure on the second subset of slots; and
transmitting a signaling message associated with the radio link failure for the second subset of slots using an uplink (UL) signal or channel.

4. The method of claim 1, further comprising determining the second reception quality based on the first reception quality and an adjustment value.

5. The method of claim 1, wherein:
the first set of parameters include a first T_evaluate_out,
the second set of parameters include a second T_evaluate_out, and
the first time period and the second time period correspond to the first T_evaluate_out and the second T_evaluate_out, respectively.

6. The method of claim 1, wherein:
the first set of parameters include a first BLER_out,
the second set of parameters include a second BLER_out, and
the first reception quality threshold and the second reception quality threshold correspond to the first BLER_out and the second BLER_out, respectively.

7. A user equipment (UE) comprising:
a transceiver configured to:
receive first information for a first set of radio link monitoring (RLM) reference signals (RSs) and a first set of parameters associated with an evaluation of the first set of RLM RSs, wherein the first set of RLM RSs corresponds to a first subset of slots from a set of slots on a cell; and
receive second information for a second set of RLM RSs and a second set of parameters associated with an evaluation of the second set of RLM RSs, wherein the second set of RLM RSs corresponds to a second subset of slots from the set of slots on the cell; and
a processor operably coupled to the transceiver, the processor configured to:
determine, based on the first set of parameters, a first reception quality for the first set of RLM RSS;
determine a radio link failure for the first subset of slots when a reception quality of any RLM RS from the first set of RLM RSs is below a first reception quality threshold for a first time period;
determine, based on the second set of parameters, a second reception quality for the second set of RLM RSs; and
determine a radio link failure for the second subset of slots when a reception quality of any RLM RS from the second set of RLM RSs is below a second reception quality threshold for a second time period,
wherein the first subset of slots does not include time-domain resources indicated for simultaneous transmission and reception on the cell, and
wherein the second subset of slots includes time-domain resources indicated for simultaneous transmission and reception on the cell.

8. The UE of claim 7, wherein the processor is further configured to determine a radio link failure for the cell based on the determination for the radio link failure for the first subset of slots and for the radio link failure the second subset of slots.

9. The UE of claim 7, wherein:
the processor is further configured to determine a secondary radio link failure based on the determination for the radio link failure on the second subset of slots; and
the transceiver is further configured to transmit a signaling message associated with the radio link failure for the second subset of slots using an uplink (UL) signal or channel.

10. The UE of claim 7, wherein the processor is further configured to determine the second reception quality based on the first reception quality and an adjustment value.

11. The UE of claim 7, wherein:
the first set of parameters include a first T_evaluate_out,
the second set of parameters include a second T_evaluate_out, and
the first time period and the second time period correspond to the first T_evaluate_out and the second T_evaluate_out, respectively.

12. The UE of claim 7, wherein:
the first set of parameters include a first BLER_out,
the second set of parameters include a second BLER_out, and
the first reception quality threshold and the second reception quality threshold correspond to the first BLER_out and the second BLER_out, respectively.

13. A base station (BS) comprising:
a transceiver configured to:
transmit first information for a first set of radio link monitoring (RLM) reference signals (RSs) and a first set of parameters associated with an evaluation of the first set of RLM RSs, wherein the first set of RLM RSs corresponds to a first subset of slots from a set of slots on a cell; and
transmit second information for a second set of RLM RSs and a second set of parameters associated with an evaluation of the second set of RLM RSs, wherein the second set of RLM RSs corresponds to a second subset of slots from the set of slots on the cell,
wherein a radio link failure for the first subset of slots is based on a reception quality, that is based on the first set of parameters, of any RLM RS from the first set of RLM RSs being below a first reception quality threshold for a first time period,
wherein a radio link failure for the second subset of slots is based on a reception quality, that is based on the first set of parameters, of any RLM RS from the second set of RLM RSs being below a second reception quality threshold for a second time period,
wherein the first subset of slots does not include time-domain resources indicated for simultaneous transmission and reception on the cell, and
wherein the second subset of slots includes time-domain resources indicated for simultaneous transmission and reception on the cell.

14. The BS of claim 13, wherein a radio link failure for the cell is based on the radio link failure for the first subset of slots and for the radio link failure the second subset of slots.

15. The BS of claim 13, wherein:
a secondary radio link failure is based on the radio link failure for the second subset of slots; and
the transceiver is further configured to receive a signaling message associated with the radio link failure for the second subset of slots via an uplink (UL) signal or channel.

16. The BS of claim 13, wherein a second reception quality for the second set of RLM RSs is based on a first reception quality for the first set of RLM RSs and an adjustment value.

17. The BS of claim 13, wherein:
the first set of parameters include a first T_evaluate_out,
the second set of parameters include a second T_evaluate_out, and
the first time period and the second time period correspond to the first T_evaluate_out and the second T_evaluate_out, respectively.

18. The BS of claim 13, wherein:
the first set of parameters include a first BLER_out,
the second set of parameters include a second BLER_out, and
the first reception quality threshold and the second reception quality threshold correspond to the first BLER_out and the second BLER_out, respectively.
